(19) United States
(12) Patent Application Publication
(10) Pub. No.: US 2024/0222048 A1
(43) Pub. Date: Jul. 4, 2024

(54) INPUT DEVICE

(71) Applicant: TS TECH CO., LTD., Asaka-shi, Saitama (JP)

(72) Inventors: Takayoshi ITO, Shioya-gun, Tochigi (JP); Kazumasa NARITA, Shioya-gun, Tochigi (JP); Akihiro MATSUMOTO, Shioya-gun, Tochigi (JP); Yusuke NAKAGAWA, Shioya-gun, Tochigi (JP); Atsushi KUSANO, Shioya-gun, Tochigi (JP); Keisuke MIZUNO, Shioya-gun, Tochigi (JP); Yuma MIYAMOTO, Shioya-gun, Tochigi (JP)

(21) Appl. No.: 18/557,861

(22) PCT Filed: Mar. 30, 2022
(86) PCT No.: PCT/JP2022/016220

§ 371 Date: Oct. 27, 2023

Related U.S. Application Data
(60) Provisional application No. 63/180,793, filed on Apr. 28, 2021.
(60) Provisional application No. 63/264,976, filed on Dec. 6, 2021.

(30) Foreign Application Priority Data
Sep. 30, 2021 (JP) 2021-161074

(51) Int. Cl. H01H 19/14; B62D 1/08; G06F 3/0362; G06F 3/041

(52) U.S. Cl. CPC H01H 19/14; B62D 1/08; G06F 3/0362; G06F 3/041; H01H 2231/026

(57) ABSTRACT

The input device includes an operating member including a grip portion configured to be gripped by a user, a recess recessed relative to a reference plane, and a rib extending along a part of an edge of the recess, and a switch unit including a first switch for detecting an input to the rib, and a second switch for detecting an input to a bottom surface of the recess. The edge of the recess is circular, and the rib extends along a part of the edge remote from the grip portion in an arcuate shape.

### TECHNICAL FIELD

The present invention relates to an input device for accepting an input from a user.

### BACKGROUND ART

An input device that is mounted on a steering wheel of a vehicle and has a touch panel that detects touch operations is known in the art (for example, Patent Document 1). The touch panel disclosed in Patent Document 1 is provided with a menu area and a direct area. Corresponding icons are displayed in the menu area and the direct area.

### PRIOR ART DOCUMENT(S)

### Patent Document(s)

Patent Document 1: JP2020-144496A

In the input device disclosed in Patent Document 1, the driver who grips the operating member (steering wheel) to perform a steering operation is required to visually recognize the touch panel to perform an input operation. Therefore, the input device of Patent Document 1 has a problem that it is difficult for the driver gripping the operating member to perform an input operation.

In view of the above background, it is an object of the present invention to provide an input device that facilitates an input operation even for a user gripping a grip portion of an operating member.

In order to solve the above problems, a certain aspect of the present invention provides an input device, comprising: an operating member including a grip portion (11, 124) configured to the gripped by a user, a recess (27) that is recessed with respect to a reference plane (S), and a rib (29) extending along a part of an edge of the recess; and a switch unit (19, 19L, 19R) including a first switch (41) configured to detect an input to a surface of the rib facing away from the recess, and a second switch (43) configured to detect an input to a bottom surface of the recess, wherein the edge of the recess is circular in shape, and the rib extends in an arcuate shape along a part of the edge remote from the grip portion.

According to this aspect, the user can sense the positions of the rib and the recess by touching the rib and the recess so that a user who is gripping the grip portion can perform an input operation with ease even without visual recognition. Further, since the rib is provided adjacent to the recess, the user can recognize the position of the recess and the rib at the same time. Furthermore, since the rib has an arcuate shape, the user can easily perform an input operation to the first switch while gripping the grip portion.

In the above aspect, preferably, the first switch is configured to acquire a contact position on a surface (29B) of the rib facing away from the recess.

According to this aspect, an erroneous input to the second switch while inputting to the first switch can be avoided.

Moreover, in the above aspect, preferably, the grip portion is positioned on an outer edge side of the recess and the rib.

According to this aspect, the user gripping the grip portion can perform an input operation to the first switch and the second switch with ease.

In the above aspect, preferably, the operating member constitutes a steering operation member (5, 125) that accepts an input of a steering angle by being rotated about a rotational axis (X, Y), and the recess and the rib are positioned closer to the rotational axis than the grip portion, the rib being positioned closer to the rotational axis than the recess.

According to this aspect, an input device is provided that facilitates an input operation for a user who grips the steering operation member and performs a steering input operation.

In the above aspect, preferably, the input device further comprises a processing device (21) that stores a relationship between the switch unit and operation objects to be operated thereby, and according to an input to the switch unit, provides an output to the corresponding operating object, the processing device ceasing an output to the operating object based on an input to the first switch and the second switch when an absolute value of the steering angle is equal to or greater than a prescribed threshold value.

According to this aspect, an unintended operation on the operating object based on an erroneous input by the user can be avoided.

In the above aspect, preferably, the switch unit is one of a pair of switch units that are provided on a rear surface of the steering operation member so as to be symmetric to each other about the rotational axis, and the input device further comprises a processing device (21) that stores a relationship between the switch units and operation objects to be operated thereby, and according to an input to the switch units, provides an output to the corresponding operating object, the processing device interchanging the operating objects of the two switch units depending on the steering angle.

According to this aspect, it is possible to change the operation objects of the switch units according to the state of the steering operation member, for example, so as to suit the user's perception.

In the above aspect, preferably, the second switch includes eight touch sensors (43C) arranged around a central axis of the recess along a circumferential direction at regular intervals, and a detection device (43B) that detects an input operation corresponding to a circumferential direction when sequential contacts of three adjoining ones of the touch sensors are detected, and detects an input operation corresponding to an upward, a downward, a leftward or a rightward direction when two adjoining ones of the touch sensors are simultaneously detected.

According to this aspect, the second switch unit can detect an input in either circumferential direction and an input in any of the four directions, up, down, left, and right.

Further, in the above aspect, preferably, the input device further comprises a processing device (21) that selects operation object of the first switch unit according to an input to the second switch, acquires a displacement of a contact position on the first switch unit, computes a set value according to a prescribed formula, and outputs the set value to each operation object, the processing device determining the formula that gives the set value from the displacement according to a nature of the operation object.

According to this aspect, the processing device can convert the swipe amount applied to the first switch unit by the user so as to match the selected operation object.

In the above aspect, preferably, the base body is provided with a cover (129) that covers both the recess and the rib.

According to this aspect, the switch unit can be protected.

In the above aspect, preferably, the steering operation member is provided on a four-wheeled vehicle (3) or a two-wheeled vehicle (123).

According to this aspect, the steering operation member can be provided with an input device that allows a user who steers a four-wheeled vehicle or a two-wheeled vehicle to perform an input operation with ease.

In order to solve the above problems, another aspect of the present invention provides a steering wheel (205), comprising: a grip portion (211) configured to be gripped by a driver; a hub portion (213) connected to a steering shaft (207); and a spoke portion (215) connecting the hub portion with the grip portion, wherein a rear surface of the spoke portion is provided with an inclined surface (225) which is inclined with respect to an imaginary plane (S) perpendicular to an axis (Z) of the steering shaft, and at least one accepting portion is provided so as to overlap with the inclined surface.

According to this aspect, since the driver can easily recognize the position of the accepting portion from the inclination angle of the inclined surface, the steering wheel facilitates an input operation for the driver.

In the above aspect, preferably, the inclined surface is inclined forward toward a radially inward part of the steering wheel with respect to the axis.

According to this aspect, since the inclined surface is inclined along the thumb of the driver who grips the grip portion, the input operation to the accepting portion is facilitated.

In the above aspect, preferably, the inclined surface includes a first inclined surface (225A), a second inclined surface (225B) extending along an outer edge of the first inclined surface and having a larger inclination angle relative to the imaginary plane, and the at least one accepting portion is positioned so as to overlap with the second inclined surface.

According to this aspect, since the accepting portion is provided so as to overlap with the second inclined surface positioned radially outward of the first inclined surface, the input operation to the accepting portion is facilitated as compared to the case where the first inclined surface is provided only in the first inclined surface.

In the above aspect, preferably, the at least one accepting portion is positioned so as to overlap with the second inclined surface, and the at least one accepting portion overlapping with the second inclined surface is configured to acquire a swipe amount.

According to this aspect, since the accepting portion that acquires a swipe amount is provided so as to overlap with the second inclined surface located radially outside of the first inclined surface, the accepting portion is positioned closer to the grip portion as compared to the case where the accepting portion for acquiring the swipe amount is provided only on the first inclined surface so that the swipe operation is facilitated

In the above aspect, preferably, the spoke portion is provided with a spoke recess (235) that is recessed forward with respect to the imaginary plane.

According to this aspect, the recess created in the spoke portion can accommodate the thumb of the driver who grips the grip portion.

In the above aspect, preferably, the spoke recess is provided with a first surface (237) that inclines rearward toward a radially outward and lower part thereof, a second surface (239) that is connected to a lower edge of the first surface and inclines forward toward a radially outward and upper part thereof, a third surface (241) that is connected to radially outer edges of the first surface and the second surface and inclines rearward toward a radially outer part thereof, and at least one accepting portion is provided on one of the first, second and third surfaces.

According to this aspect, since the thumb can be accommodated in the recess created in the spoke portion and the thumb can be used for the input operation, a steering wheel is provided that facilitates an input operation for the driver.

In the above aspect, preferably, a ridge (245) created between the second surface and the third surface inclines rearward toward a downward and radially outer part thereof.

According to this aspect, the ridge defined by the second surface and the third surface extends in the direction extending along the length of the thumb. Therefore, the driver can easily place the thumb between the second surface and the third surface so that the input operation to the accepting portion is facilitated.

In the above aspect, preferably, the third surface is provided with at least one accepting portion (227G) that accepts an input operation related to a turn signal operation.

According to this aspect, the accepting portion provided on the third surface accepts an input operation for the turn signal which is frequently performed. Therefore, compared to the case where the accepting portion for receiving the input operation for the turn signal is provided on the first surface or the second surface, the accepting portion for receiving the input operation for the turn signal is positioned on a comparatively radially outer position so that the operability of the steering wheel is improved.

In order to solve the above problems, yet another aspect of the present invention provides a steering switch unit (253) for a steering wheel comprising a grip portion (211) configured to be gripped by a driver, a hub portion (213) connected to a steering shaft (207), and a spoke main body (261) provided with a main body recess (255) recessed forward, the steering switch unit (253) forming a spoke portion (215) that connects the grip portion and the hub portion to each other jointly with the spoke main body, wherein the steering switch unit includes a base body (251) that is fitted into the main body recess, and defines a rear surface of the spoke portion, and a touch sensor (233) provided on the rear surface of the base body for accepting an input operation from the driver, and the spoke portion includes an inclined surface (225) which is inclined with respect to an imaginary plane orthogonal to an axis of the steering shaft connected to the hub portion, at least a part of the touch sensor being positioned on the inclined surface.

According to this aspect, since the driver can easily perceive the position of the accepting portion from the inclination angle of the inclined surface, the input operation to the steering switch unit by the driver can be facilitated.

In order to solve the above problems, yet another aspect of the present invention provides a steering wheel (205) comprising a grip portion (211) configured to be gripped by a driver, a hub portion (213) connected to a steering shaft (207), and a spoke portion (215) connecting the hub portion and the grip portion to each other, wherein a rear surface of the spoke portion is provided with a spoke recess (235) that is recessed forward, and at least a part of an accepting portion (227) for accepting an input operation from the driver is positioned so as to overlap with a surface defining the spoke recess.

According to this aspect, the accepting portion that accepts the input operation from the driver is provided so as to overlap with the spoke recess. Therefore, the driver can recognize the position of the spoke recess by touching it, and can understand the position of the accepting portion without visually recognizing it. Therefore, a steering wheel that facilitates an input for the driver is provided. Therefore, by tactile sense, the driver is enabled to recognize the position of the spoke recess, and identify the position of the accepting portion without visual recognition. Thus, a steering wheel which facilitates the input operation of the driver is provided.

In the above aspect, preferably the surface defining the spoke recess includes a first surface (237) and a second surface (239) connected to a lower edge of the first surface, the first surface and the second surface forming an angle equal to or greater than 90 degrees.

According to this aspect, since the spoke recess is not excessively deep, the driver can easily perform the input operation to the accepting portion.

In the above aspect, preferably, the surface defining the spoke recess includes a first surface (237), a second surface (239) having an inclination angle different from that of the first surface, and a third surface (241) connected to the first surface and the second surface and having an inclination angle different from those of the first surface and the second surface, the accepting portion being provided on at least two of the first surface, the second surface and the third surface.

According to this aspect, since the driver can distinguish the surfaces defining the spoke recess based on the inclination angles, the driver can perform the input operations to the accepting portions provided on the respective surfaces in a selective manner.

In the above aspect, preferably, the first surface and the second surface are connected by a first ridge (243), the second surface and the third surface are connected by a second ridge (245), and the third surface and the first surface are connected by a third ridge (247), and an angle formed by the first ridge and the second ridge, an angle formed by the second ridge and the third ridge, and an angle formed by the third ridge and the first ridge are each equal to or greater than 90 degrees.

According to this aspect, since the spoke recess is not excessively deep, the driver can easily perform the input operation to the accepting portion.

In the above aspect, preferably, the first surface and the second surface are connected by a first ridge (243), the second surface and the third surface are connected by a second ridge (245), and the third surface and the first surface are connected by a third ridge (247), the second surface is provided below the first surface, the third surface is located on a side of the first surface and the second surface remote from the axis of the steering shaft, and the second ridge inclines downward and rearward as one moves away from the axis.

According to this aspect, the ridge defined by the second surface and the third surface extends along the length of the thumb. Accordingly, the driver can easily place the thumb between the second surface and the third surface so that the input operation to the accepting portion is facilitated.

In the above aspect, preferably, the third surface is provided with the accepting portion (227G) that accepts an input operation for a turn signal.

According to this aspect, the accepting portion provided on the third surface accepts an input operation for the turn signal which is frequently inputted. Therefore, compared to the case where the accepting portion for receiving the input operation for the turn signal is provided on the first surface or the second surface, since the accepting portion for receiving the input operation for the turn signal is positioned on a radially outer part, the operability of the steering wheel can be improved

In the above aspect, preferably, one of the first surface, the second surface, and the third surface is provided with a rib extending in a predetermined direction and dividing the corresponding surface into two parts (229C, 229D), each of which is provided with an accepting portion.

According to this aspect, the driver can recognize the position of the rib by contact. Therefore, the driver can selectively perform an input operation to the accepting portions provided in the parts divided by the rib.

In order to solve the above problems, yet another aspect of the present invention provides a steering switch unit (253) for a steering wheel comprising a grip portion (211) configured to be gripped by a driver, a hub portion (213) connected to a steering shaft (207), and a spoke main body (261) provided with a main body recess recessed forward, the steering switch unit (253) forming a spoke portion (215) that connects the grip portion and the hub portion to each other jointly with the spoke main body, wherein the steering switch unit includes a base body fitted into the main body recess to define a rear surface of the spoke portion, and a touch sensor (233) provided on a rear surface of the base body and configured to accept an input operation by being contacted by the driver, and wherein the rear surface of the base body is provided with a spoke recess (235) recessed forward, and at least a part of the touch sensor is positioned so as to overlap with a surface defining the spoke recess.

According to this aspect, since the accepting portion that accepts the input operation from the driver is provided so as to overlap with the spoke recess, the driver can recognize the position of the spoke recess by tactile sense, and can identify the position of the accepting portion without visual recognition. Therefore, a steering switch unit is provided that facilitates an input operation by the driver.

In order to solve the above problem, yet another aspect of the present invention provides a steering wheel (205), comprising: a grip portion (211) configured to be gripped by a driver, a hub portion (213) connected to a steering shaft (207), and a spoke portion (215) that connects the hub portion and the grip portion to each other, wherein a rear surface of the spoke portion is provided with a pair of accepting portions (227) each configured to accept an input operation from the driver, and a pair of ribs (229A, 229B) provided in the respective accepting portions and projecting rearward and extending in predetermined mutually different directions.

According to this aspect, since the driver can recognize the extending directions of the ribs by touching the ribs. Therefore, a steering wheel is provided that facilitates an input operation by the driver.

In the above aspect, preferably, one of the ribs (229A) approaches the axis of the steering shaft as it extends downward from above, and the other rib (227B) moves away from the axis of the steering shaft as it extends downward from above.

According to this aspect, since the driver can identify the ribs by tracing the ribs in the vertical direction, and determining if the extending directions of the ribs approach the axis or not, the driver can selectively perform an input operation to each accepting portion.

In the above aspect, preferably, at least one of the accepting portions is configured to accept an input operation corresponding to a swipe amount in a direction intersecting the corresponding rib.

According to this aspect, the driver can easily understand the position where the swipe input should be performed from the position of the rib.

In the above aspect, preferably, the rear surface of the spoke portion is provided with an inclined surface (225) that is inclined with respect to an imaginary plane perpendicular to the axis of the steering shaft, and the ribs extend along the inclined surface.

According to this aspect, the driver can easily recognize the positions where the ribs are provided by the inclination angle of the inclined surface.

In the above aspect, preferably, the inclined surface includes a first inclined surface (225A) and a second inclined surface (225B) provided on an outer edge side of the first inclined surface on the spoke portion, and having a larger inclination angle relative to the imaginary plane than the first inclined surface, and the ribs extend along the second inclined surface.

According to this aspect, since the accepting portions are provided so as to extend on the second inclined surface located radially outward of the first inclined surface, the accepting portions are closer to the grip portion so that the input operation is facilitated.

In the above aspect, preferably, the accepting portion (227A) corresponding to one of the ribs is located on a side edge part of the rear surface of the spoke portion, and the accepting portion (227B) corresponding to the other rib is located on an upper edge part of the rear surface of the spoke portion.

According to this aspect, the locations for performing input operations are provided at the side edge part and the upper edge part of the spoke portion. Therefore, the driver can easily recognize the positions where the desired input operations should be made.

In the above aspect, preferably, at least one of the accepting portions (227A) extends downward while being inclined toward the grip portion.

According to this aspect, since the accepting portion is provided along the region over which the driver can slide the thumb while holding the grip portion, the input operation to the accepting portion is facilitated.

In order to solve the above problems, yet another aspect of the present invention provides a steering switch unit (253) for a steering wheel comprising a grip portion (211) configured to be gripped by a driver, a hub portion (213) connected to a steering shaft (207), and a spoke main body (261) provided with a main body recess (255) recessed forward, the steering switch unit (253) forming a spoke portion (215) that connects the grip portion and the hub portion to each other jointly with the spoke main body, wherein the steering switch unit includes a base body (251) that is fitted into the main body recess to define a rear surface of the spoke, and a touch sensor (233) configured to acquire a swipe amount applied to a detection area provided on the rear surface by the driver, and a pair of ribs (229A, 229B) protruding rearward from the rear surface of the base body are provided in the detection area and extend in predetermined directions which are different from each other.

According to this aspect, since the driver can recognize the extending directions of the ribs by touching, the driver is enabled to selectively perform touch operations to the respective accepting portions. Thus, a steering switch unit that facilitates input operations by the driver can be provided.

Further, a vehicle steering wheel having a steering switch for operating on-vehicle equipment is known in the art (for example, JP2011-233449A). The steering switch disclosed in JP2011-233449A includes a switch body, a plurality of operation knobs provided on the front side of the switch body and each having a translucent display portion, and a circuit board received in the switch body, and a rubber member interposed between the circuit board and the switch body.

Each operation knob is pivotally supported by a corresponding shaft portion formed in the switch body. A plurality of fixed contacts and a plurality of LEDs serving as light sources are provided on the surface of the circuit board facing the rubber member. The rubber member is provided with movable contacts, and elastic pressing portions that protrude from the rubber member and are configured to press the corresponding fixed contacts as a result of the pivotal movement of the corresponding operation knobs. A desired switch operation is performed by selectively connecting and disconnecting each fixed contact to and from the movable contact provided on the corresponding elastic operating portion by the pivotal movement of the corresponding operation knob.

A part of the rubber member facing each LED is provided with a thin-walled light-transmitting portion. The light emitted from each LED passes through the corresponding light-transmitting portion of the rubber member, and illuminates the display portion provided on the corresponding operation knob.

In such a steering wheel, when operating the switch, the driver needs to apply a load to the operation knob with a sufficient magnitude to cause the movable contact to be conductively connected to the fixed contact. Therefore, the switch operation is not performed when the driver inadvertently touches the switch body with a light pressure so that an erroneous operation can be prevented. Another advantage is that the driver can recognize if the switch operation has been performed by the displacement of the operation knob.

However, in such a steering wheel, it is necessary to provide a number of sets of a movable contact and a fixed contact corresponding to the accepting portions (operation knob) each configured to accept an input operation from the driver. Therefore, as the number of accepting portions increases, it becomes a problem that the structure of the steering wheel becomes unacceptably complicated. Therefore, there is a task to provide a steering switch unit which has a simple structure but is provided with a plurality of accepting portions each configured to accept an input operation from the driver and capable of determining if an appropriate pressure is applied thereto, and a steering wheel fitted with such a steering switch unit.

In order to solve the above problem, yet another aspect of the present invention provides a steering wheel (5) comprising a grip portion (11) configured to be gripped by a driver, a hub portion (13) connected to a steering shaft (7), and a spoke portion (15) that connects the grip portion and the hub portion to each other, wherein the spoke portion includes a spoke main body (51) provided with a main body recess on a rear surface thereof, and a steering switch unit (53) fitted in the main body recess, the steering switch unit including a base body (61) forming at least a part of a rear surface of the spoke portion, a touch sensor (33) provided on a rear surface of the base body, and a press switch (79) provided between the base body and a wall surface defining the main body recess.

According to this aspect, the position of the input operation from the driver can be acquired by the touch sensor. Furthermore, it can be determined if a sufficient load has been applied to the accepting portion by the press switch. Since it is not necessary to provide a press switch for each position for an input operation for detecting the contact of the driver and determining whether or not a sufficient load is applied to the corresponding position where the input operation is to be performed, the structure of the steering wheel is simplified.

In the above aspect, preferably, the base body includes a front housing (71) that forms a rear surface of the spoke portion and is translucent at least at a part thereof corresponding to the touch sensor, and an intermediate housing (73) provided on a front side of the front housing, wherein a circuit board (67) having a surface facing in a fore and aft direction is provided between the intermediate housing and the main body recess, and a rear surface of the circuit board is provided with a plurality of light sources (65) which are positioned so as to correspond to positions (27) for accepting input operation to the touch sensor.

According to this aspect, the light sources emit light rearward and illuminate the positions of the front housing for receiving input operations from the front side. Therefore, the driver can easily visually recognize the position where the input operation should be performed.

In the above aspect, preferably, a diffuser (69) for diffusing light is provided between the light sources, the diffuser connecting the circuit board and the front housing to each other.

According to this aspect, the part of the light emitted from the light sources which is directed to regions other than gaps in the diffuser is diffused by the diffuser. As a result, the parts of the front housing corresponding to the light sources emit light more distinctly than the other parts so that the visibility of the positions where the input operation is to be performed is improved.

In the above aspect, preferably, the press switch is provided on the front surface of the circuit board.

According to this aspect, the press switch can be provided between the base body and the wall surface defining the main body recess so that the switch is operated by a forward pressure applied to the base body.

In the above aspect, preferably, the press switch is provided on the bottom surface (59) of the body recess.

According to this aspect, the press switch can be provided between the base body and the wall surface defining the main body recess so that the switch is operated by a forward pressure applied to the base body.

In the above aspect, preferably, an elastic member (77) is provided between the intermediate housing and the wall surface (59) defining the main body recess.

According to this aspect, the base body can be accommodated in the main body recess so as to be movable with respect to the spoke main body.

In the above aspect, preferably the touch sensor is connected to the circuit board via a cable.

According to this aspect, a tensile load is prevented from being applied to the cable connected to the touch sensor due to the displacement of the base body with respect to the spoke body.

In order to solve the above-mentioned problems, yet another aspect of the present invention provides a steering switch unit (53) provided in a steering wheel (5) comprising a grip portion (11) configured to be gripped by a driver, a hub portion (13) connected to a steering shaft (7), and a spoke main body (51) provided with a main body recess recessed forward, the steering switch unit (53) forming a spoke portion (215) that connects the grip portion and the hub portion to each other jointly with the spoke main body, wherein the steering switch unit includes a base body (61) fitted in the main body recess and forming at least a part of a rear surface of the spoke portion, a touch sensor (33) provided on a rear surface of the base body, and a press switch (79) provided between the base body and a wall surface defining the main body recess so as to perform a switch operation by a forward pressure applied to the base body.

According to this aspect, accepting portions that can respectively accept input operations from the driver by means of the touch sensor can be formed on the rear surface of the base body. Furthermore, the press switch allows to determine if a sufficient load has been applied to the accepting portions. Moreover, since the press switch is not required to be provided for each touch switch, the structure of the steering wheel is simplified.

### Effect of the Invention

In order to solve the above problems, a certain aspect of the present invention provides an input device, comprising: an operating member including a grip portion (11, 124) configured to the gripped by a user, a recess (27) that is recessed with respect to a reference plane (S), and a rib (29) extending along a part of an edge of the recess; and a switch unit (19, 19L, 19R) including a first switch (41) configured to detect an input to a surface of the rib facing away from the recess, and a second switch (43) configured to detect an input to a bottom surface of the recess, wherein the edge of the recess is circular in shape, and the rib extends in an arcuate shape along a part of the edge remote from the grip portion.

According to this aspect, the user can sense the positions of the rib and the recess by touching the rib and the recess so that a user who is gripping the grip portion can perform an input operation with ease even without visual recognition. Further, since the rib is provided adjacent to the recess, the user can recognize the position of the recess and the rib at the same time. Furthermore, since the rib has an arcuate shape, the user can easily perform an input operation to the first switch while gripping the grip portion.

In the above aspect, preferably, the first switch is configured to acquire a contact position on a surface (29B) of the rib facing away from the recess.

According to this aspect, an erroneous input to the second switch while inputting to the first switch can be avoided.

Moreover, in the above aspect, preferably, the grip portion is positioned on an outer edge side of the recess and the rib.

According to this aspect, the user gripping the grip portion can perform an input operation to the first switch and the second switch with ease.

In the above aspect, preferably, the operating member constitutes a steering operation member (5, 125) that accepts an input of a steering angle by being rotated about a rotational axis (X, Y), and the recess and the rib are positioned closer to the rotational axis than the grip portion, the rib being positioned closer to the rotational axis than the recess.

According to this aspect, an input device is provided that facilitates an input operation for a user who grips the steering operation member and performs a steering input operation.

In the above aspect, preferably, the input device further comprises a processing device (21) that stores a relationship between the switch unit and operation objects to be operated thereby, and according to an input to the switch unit, provides an output to the corresponding operating object, the processing device ceasing an output to the operating object based on an input to the first switch and the second switch when an absolute value of the steering angle is equal to or greater than a prescribed threshold value.

According to this aspect, an unintended operation on the operating object based on an erroneous input by the user can be avoided.

In the above aspect, preferably, the switch unit is one of a pair of switch units that are provided on a rear surface of the steering operation member so as to be symmetric to each other about the rotational axis, and the input device further comprises a processing device (21) that stores a relationship between the switch units and operation objects to be operated thereby, and according to an input to the switch units, provides an output to the corresponding operating object, the processing device interchanging the operating objects of the two switch units depending on the steering angle.

According to this aspect, it is possible to change the operation objects of the switch units according to the state of the steering operation member, for example, so as to suit the user's perception.

In the above aspect, preferably, the second switch includes eight touch sensors (43C) arranged around a central axis of the recess along a circumferential direction at regular intervals, and a detection device (43B) that detects an input operation corresponding to a circumferential direction when sequential contacts of three adjoining ones of the touch sensors are detected, and detects an input operation corresponding to an upward, a downward, a leftward or a rightward direction when two adjoining ones of the touch sensors are simultaneously detected.

According to this aspect, the second switch unit can detect an input in either circumferential direction and an input in any of the four directions, up, down, left, and right.

Further, in the above aspect, preferably, the input device further comprises a processing device (21) that selects operation object of the first switch unit according to an input to the second switch, acquires a displacement of a contact position on the first switch unit, computes a set value according to a prescribed formula, and outputs the set value to each operation object, the processing device determining the formula that gives the set value from the displacement according to a nature of the operation object.

According to this aspect, the processing device can convert the swipe amount applied to the first switch unit by the user so as to match the selected operation object.

In the above aspect, preferably, the base body is provided with a cover (129) that covers both the recess and the rib.

According to this aspect, the switch unit can be protected.

In the above aspect, preferably, the steering operation member is provided on a four-wheeled vehicle (3) or a two-wheeled vehicle (123).

According to this aspect, the steering operation member can be provided with an input device that allows a user who steers a four-wheeled vehicle or a two-wheeled vehicle to perform an input operation with ease.

In order to solve the above problems, another aspect of the present invention provides a steering wheel (205), comprising: a grip portion (211) configured to be gripped by a driver; a hub portion (213) connected to a steering shaft (207); and a spoke portion (215) connecting the hub portion with the grip portion, wherein a rear surface of the spoke portion is provided with an inclined surface (225) which is inclined with respect to an imaginary plane (S) perpendicular to an axis (Z) of the steering shaft, and at least one accepting portion is provided so as to overlap with the inclined surface.

According to this aspect, since the driver can easily recognize the position of the accepting portion from the inclination angle of the inclined surface, the steering wheel facilitates an input operation for the driver.

In the above aspect, preferably, the inclined surface is inclined forward toward a radially inward part of the steering wheel with respect to the axis.

According to this aspect, since the inclined surface is inclined along the thumb of the driver who grips the grip portion, the input operation to the accepting portion is facilitated.

In the above aspect, preferably, the inclined surface includes a first inclined surface (225A), a second inclined surface (225B) extending along an outer edge of the first inclined surface and having a larger inclination angle relative to the imaginary plane, and the at least one accepting portion is positioned so as to overlap with the second inclined surface.

According to this aspect, since the accepting portion is provided so as to overlap with the second inclined surface positioned radially outward of the first inclined surface, the input operation to the accepting portion is facilitated as compared to the case where the first inclined surface is provided only in the first inclined surface.

In the above aspect, preferably, the at least one accepting portion is positioned so as to overlap with the second inclined surface, and the at least one accepting portion overlapping with the second inclined surface is configured to acquire a swipe amount.

According to this aspect, since the accepting portion that acquires a swipe amount is provided so as to overlap with the second inclined surface located radially outside of the first inclined surface, the accepting portion is positioned closer to the grip portion as compared to the case where the accepting portion for acquiring the swipe amount is provided only on the first inclined surface so that the swipe operation is facilitated

In the above aspect, preferably, the spoke portion is provided with a spoke recess (235) that is recessed forward with respect to the imaginary plane.

According to this aspect, the recess created in the spoke portion can accommodate the thumb of the driver who grips the grip portion.

In the above aspect, preferably, the spoke recess is provided with a first surface (237) that inclines rearward toward a radially outward and lower part thereof, a second surface (239) that is connected to a lower edge of the first surface and inclines forward toward a radially outward and upper part thereof, a third surface (241) that is connected to radially outer edges of the first surface and the second surface and inclines rearward toward a radially outer part thereof, and at least one accepting portion is provided on one of the first, second and third surfaces.

According to this aspect, since the thumb can be accommodated in the recess created in the spoke portion and the thumb can be used for the input operation, a steering wheel is provided that facilitates an input operation for the driver.

In the above aspect, preferably, a ridge (245) created between the second surface and the third surface inclines rearward toward a downward and radially outer part thereof.

According to this aspect, the ridge defined by the second surface and the third surface extends in the direction extending along the length of the thumb. Therefore, the driver can easily place the thumb between the second surface and the third surface so that the input operation to the accepting portion is facilitated.

In the above aspect, preferably, the third surface is provided with at least one accepting portion (227G) that accepts an input operation related to a turn signal operation.

According to this aspect, the accepting portion provided on the third surface accepts an input operation for the turn signal which is frequently performed. Therefore, compared to the case where the accepting portion for receiving the input operation for the turn signal is provided on the first surface or the second surface, the accepting portion for receiving the input operation for the turn signal is positioned on a comparatively radially outer position so that the operability of the steering wheel is improved.

In order to solve the above problems, yet another aspect of the present invention provides a steering switch unit (253) for a steering wheel comprising a grip portion (211) configured to be gripped by a driver, a hub portion (213) connected to a steering shaft (207), and a spoke main body (261) provided with a main body recess (255) recessed forward, the steering switch unit (253) forming a spoke portion (215) that connects the grip portion and the hub portion to each other jointly with the spoke main body, wherein the steering switch unit includes a base body (251) that is fitted into the main body recess, and defines a rear surface of the spoke portion, and a touch sensor (233) provided on the rear surface of the base body for accepting an input operation from the driver, and the spoke portion includes an inclined surface (225) which is inclined with respect to an imaginary plane orthogonal to an axis of the steering shaft connected to the hub portion, at least a part of the touch sensor being positioned on the inclined surface.

According to this aspect, since the driver can easily perceive the position of the accepting portion from the inclination angle of the inclined surface, the input operation to the steering switch unit by the driver can be facilitated.

In order to solve the above problems, yet another aspect of the present invention provides a steering wheel (205) comprising a grip portion (211) configured to be gripped by a driver, a hub portion (213) connected to a steering shaft (207), and a spoke portion (215) connecting the hub portion and the grip portion to each other, wherein a rear surface of the spoke portion is provided with a spoke recess (235) that is recessed forward, and at least a part of an accepting portion (227) for accepting an input operation from the driver is positioned so as to overlap with a surface defining the spoke recess.

According to this aspect, the accepting portion that accepts the input operation from the driver is provided so as to overlap with the spoke recess. Therefore, the driver can recognize the position of the spoke recess by touching it, and can understand the position of the accepting portion without visually recognizing it. Therefore, a steering wheel that facilitates an input for the driver is provided. Therefore, by tactile sense, the driver is enabled to recognize the position of the spoke recess, and identify the position of the accepting portion without visual recognition. Thus, a steering wheel which facilitates the input operation of the driver is provided.

In the above aspect, preferably the surface defining the spoke recess includes a first surface (237) and a second surface (239) connected to a lower edge of the first surface, the first surface and the second surface forming an angle equal to or greater than 90 degrees.

According to this aspect, since the spoke recess is not excessively deep, the driver can easily perform the input operation to the accepting portion.

In the above aspect, preferably, the surface defining the spoke recess includes a first surface (237), a second surface (239) having an inclination angle different from that of the first surface, and a third surface (241) connected to the first surface and the second surface and having an inclination angle different from those of the first surface and the second surface, the accepting portion being provided on at least two of the first surface, the second surface and the third surface.

According to this aspect, since the driver can distinguish the surfaces defining the spoke recess based on the inclination angles, the driver can perform the input operations to the accepting portions provided on the respective surfaces in a selective manner.

In the above aspect, preferably, the first surface and the second surface are connected by a first ridge (243), the second surface and the third surface are connected by a second ridge (245), and the third surface and the first surface are connected by a third ridge (247), and an angle formed by the first ridge and the second ridge, an angle formed by the second ridge and the third ridge, and an angle formed by the third ridge and the first ridge are each equal to or greater than 90 degrees.

According to this aspect, since the spoke recess is not excessively deep, the driver can easily perform the input operation to the accepting portion.

In the above aspect, preferably, the first surface and the second surface are connected by a first ridge (243), the second surface and the third surface are connected by a second ridge (245), and the third surface and the first surface are connected by a third ridge (247), the second surface is provided below the first surface, the third surface is located on a side of the first surface and the second surface remote from the axis of the steering shaft, and the second ridge inclines downward and rearward as one moves away from the axis.

According to this aspect, the ridge defined by the second surface and the third surface extends along the length of the thumb. Accordingly, the driver can easily place the thumb between the second surface and the third surface so that the input operation to the accepting portion is facilitated.

In the above aspect, preferably, the third surface is provided with the accepting portion (227G) that accepts an input operation for a turn signal.

According to this aspect, the accepting portion provided on the third surface accepts an input operation for the turn signal which is frequently inputted. Therefore, compared to the case where the accepting portion for receiving the input operation for the turn signal is provided on the first surface or the second surface, since the accepting portion for receiving the input operation for the turn signal is positioned on a radially outer part, the operability of the steering wheel can be improved

In the above aspect, preferably, one of the first surface, the second surface, and the third surface is provided with a rib extending in a predetermined direction and dividing the corresponding surface into two parts (229C, 229D), each of which is provided with an accepting portion.

According to this aspect, the driver can recognize the position of the rib by contact. Therefore, the driver can selectively perform an input operation to the accepting portions provided in the parts divided by the rib.

In order to solve the above problems, yet another aspect of the present invention provides a steering switch unit (253) for a steering wheel comprising a grip portion (211) configured to be gripped by a driver, a hub portion (213) connected to a steering shaft (207), and a spoke main body (261) provided with a main body recess recessed forward, the steering switch unit (253) forming a spoke portion (215) that connects the grip portion and the hub portion to each other jointly with the spoke main body, wherein the steering switch unit includes a base body fitted into the main body recess to define a rear surface of the spoke portion, and a touch sensor (233) provided on a rear surface of the base body and configured to accept an input operation by being contacted by the driver, and wherein the rear surface of the base body is provided with a spoke recess (235) recessed forward, and at least a part of the touch sensor is positioned so as to overlap with a surface defining the spoke recess.

According to this aspect, since the accepting portion that accepts the input operation from the driver is provided so as to overlap with the spoke recess, the driver can recognize the position of the spoke recess by tactile sense, and can identify the position of the accepting portion without visual recognition. Therefore, a steering switch unit is provided that facilitates an input operation by the driver.

In order to solve the above problem, yet another aspect of the present invention provides a steering wheel (205), comprising: a grip portion (211) configured to be gripped by a driver, a hub portion (213) connected to a steering shaft (207), and a spoke portion (215) that connects the hub portion and the grip portion to each other, wherein a rear surface of the spoke portion is provided with a pair of accepting portions (227) each configured to accept an input operation from the driver, and a pair of ribs (229A, 229B) provided in the respective accepting portions and projecting rearward and extending in predetermined mutually different directions.

According to this aspect, since the driver can recognize the extending directions of the ribs by touching the ribs. Therefore, a steering wheel is provided that facilitates an input operation by the driver.

In the above aspect, preferably, one of the ribs (229A) approaches the axis of the steering shaft as it extends downward from above, and the other rib (227B) moves away from the axis of the steering shaft as it extends downward from above.

According to this aspect, since the driver can identify the ribs by tracing the ribs in the vertical direction, and determining if the extending directions of the ribs approach the axis or not, the driver can selectively perform an input operation to each accepting portion.

In the above aspect, preferably, at least one of the accepting portions is configured to accept an input operation corresponding to a swipe amount in a direction intersecting the corresponding rib.

According to this aspect, the driver can easily understand the position where the swipe input should be performed from the position of the rib.

In the above aspect, preferably, the rear surface of the spoke portion is provided with an inclined surface (225) that is inclined with respect to an imaginary plane perpendicular to the axis of the steering shaft, and the ribs extend along the inclined surface.

According to this aspect, the driver can easily recognize the positions where the ribs are provided by the inclination angle of the inclined surface.

In the above aspect, preferably, the inclined surface includes a first inclined surface (225A) and a second inclined surface (225B) provided on an outer edge side of the first inclined surface on the spoke portion, and having a larger inclination angle relative to the imaginary plane than the first inclined surface, and the ribs extend along the second inclined surface.

According to this aspect, since the accepting portions are provided so as to extend on the second inclined surface located radially outward of the first inclined surface, the accepting portions are closer to the grip portion so that the input operation is facilitated.

In the above aspect, preferably, the accepting portion (227A) corresponding to one of the ribs is located on a side edge part of the rear surface of the spoke portion, and the accepting portion (227B) corresponding to the other rib is located on an upper edge part of the rear surface of the spoke portion.

According to this aspect, the locations for performing input operations are provided at the side edge part and the upper edge part of the spoke portion. Therefore, the driver can easily recognize the positions where the desired input operations should be made.

In the above aspect, preferably, at least one of the accepting portions (227A) extends downward while being inclined toward the grip portion.

According to this aspect, since the accepting portion is provided along the region over which the driver can slide the thumb while holding the grip portion, the input operation to the accepting portion is facilitated.

In order to solve the above problems, yet another aspect of the present invention provides a steering switch unit (253) for a steering wheel comprising a grip portion (211) configured to be gripped by a driver, a hub portion (213) connected to a steering shaft (207), and a spoke main body (261) provided with a main body recess (255) recessed forward, the steering switch unit (253) forming a spoke portion (215) that connects the grip portion and the hub portion to each other jointly with the spoke main body, wherein the steering switch unit includes a base body (251) that is fitted into the main body recess to define a rear surface of the spoke, and a touch sensor (233) configured to acquire a swipe amount applied to a detection area provided on the rear surface by the driver, and a pair of ribs (229A, 229B) protruding rearward from the rear surface of the base body are provided in the detection area and extend in predetermined directions which are different from each other.

According to this aspect, since the driver can recognize the extending directions of the ribs by touching, the driver is enabled to selectively perform touch operations to the respective accepting portions. Thus, a steering switch unit that facilitates input operations by the driver can be provided.

In order to solve the above problem, yet another aspect of the present invention provides a steering wheel (5) comprising a grip portion (11) configured to be gripped by a driver, a hub portion (13) connected to a steering shaft (7), and a spoke portion (15) that connects the grip portion and the hub portion to each other, wherein the spoke portion includes a spoke main body (51) provided with a main body recess on a rear surface thereof, and a steering switch unit (53) fitted in the main body recess, the steering switch unit including a base body (61) forming at least a part of a rear surface of the spoke portion, a touch sensor (33) provided on a rear surface of the base body, and a press switch (79) provided between the base body and a wall surface defining the main body recess.

According to this aspect, the position of the input operation from the driver can be acquired by the touch sensor. Furthermore, it can be determined if a sufficient load has been applied to the accepting portion by the press switch. Since it is not necessary to provide a press switch for each position for an input operation for detecting the contact of the driver and determining whether or not a sufficient load is applied to the corresponding position where the input operation is to be performed, the structure of the steering wheel is simplified.

In the above aspect, preferably, the base body includes a front housing (71) that forms a rear surface of the spoke portion and is translucent at least at a part thereof corresponding to the touch sensor, and an intermediate housing (73) provided on a front side of the front housing, wherein a circuit board (67) having a surface facing in a fore and aft direction is provided between the intermediate housing and the main body recess, and a rear surface of the circuit board is provided with a plurality of light sources (65) which are positioned so as to correspond to positions (27) for accepting input operation to the touch sensor.

According to this aspect, the light sources emit light rearward and illuminate the positions of the front housing for receiving input operations from the front side.

Therefore, the driver can easily visually recognize the position where the input operation should be performed.

In the above aspect, preferably, a diffuser (69) for diffusing light is provided between the light sources, the diffuser connecting the circuit board and the front housing to each other.

According to this aspect, the part of the light emitted from the light sources which is directed to regions other than gaps in the diffuser is diffused by the diffuser. As a result, the parts of the front housing corresponding to the light sources emit light more distinctly than the other parts so that the visibility of the positions where the input operation is to be performed is improved.

In the above aspect, preferably, the press switch is provided on the front surface of the circuit board.

According to this aspect, the press switch can be provided between the base body and the wall surface defining the main body recess so that the switch is operated by a forward pressure applied to the base body.

In the above aspect, preferably, the press switch is provided on the bottom surface (59) of the body recess.

According to this aspect, the press switch can be provided between the base body and the wall surface defining the main body recess so that the switch is operated by a forward pressure applied to the base body.

In the above aspect, preferably, an elastic member (77) is provided between the intermediate housing and the wall surface (59) defining the main body recess.

According to this aspect, the base body can be accommodated in the main body recess so as to be movable with respect to the spoke main body.

In the above aspect, preferably the touch sensor is connected to the circuit board via a cable.

According to this aspect, a tensile load is prevented from being applied to the cable connected to the touch sensor due to the displacement of the base body with respect to the spoke body.

In order to solve the above-mentioned problems, yet another aspect of the present invention provides a steering switch unit (53) provided in a steering wheel (5) comprising a grip portion (11) configured to be gripped by a driver, a hub portion (13) connected to a steering shaft (7), and a spoke main body (51) provided with a main body recess recessed forward, the steering switch unit (53) forming a spoke portion (215) that connects the grip portion and the hub portion to each other jointly with the spoke main body, wherein the steering switch unit includes a base body (61) fitted in the main body recess and forming at least a part of a rear surface of the spoke portion, a touch sensor (33) provided on a rear surface of the base body, and a press switch (79) provided between the base body and a wall surface defining the main body recess so as to perform a switch operation by a forward pressure applied to the base body.

According to this aspect, accepting portions that can respectively accept input operations from the driver by means of the touch sensor can be formed on the rear surface of the base body. Furthermore, the press switch allows to determine if a sufficient load has been applied to the accepting portions. Moreover, since the press switch is not required to be provided for each touch switch, the structure of the steering wheel is simplified.

### BRIEF DESCRIPTION OF THE DRAWING

FIG. 1 is a front view of a steering wheel provided with an input device according to a first embodiment of the present invention;

FIG. 2 is a front view of a switch unit in the input device of the first embodiment;

FIG. 3 is a perspective view of the switch unit in the input device of the first embodiment;

FIG. 4 is a sectional view taken along line IV-IV of FIG. 3:

FIG. 5 is a diagram illustrating a detecting portion of a second switch;

FIG. 6 is a determination table for detecting a swipe operation and a touch operation according to a detection result of the detecting portion of the second switch;

FIG. 7 is a functional block diagram including the input device of the first embodiment and various devices that are to be the objects to be operated on;

FIG. 8 is a simplified view showing a screen for selecting objects to be operated;

FIG. 9 is a simplified view showing a screen for changing various set values;

FIG. 10 is a front view of a steering wheel provided with an input device according to a second embodiment of the present invention;

FIG. 11 is a front view of a steering wheel provided with an input device according to a third embodiment of the present invention;

FIG. 12 is a front view of a switch unit of an input device according to a first modified embodiment of the present invention as modified from the input devices of the first to third embodiments;

FIG. 13 is a perspective of the switch unit of the input device of the first modified embodiment;

FIG. 14 is a sectional view taken along line XIV-XIV of FIG. 13;

FIG. 15 is a front view showing a switch unit of an input device according to a second modified embodiment of the present invention as modified from the input devices of the first to third embodiments;

FIG. 16 is a perspective view of the switch unit of the second modified embodiment;

FIG. 17 is a sectional view taken along line XVII-XVII of FIG. 15;

FIG. 18 is a view showing an input device according to a third modified embodiment of the present invention as modified from the input devices of the first to third embodiment;

FIG. 19 is a view showing an input device according to a fourth modified embodiment of the present invention as modified from the input devices of the first to third embodiment;

FIG. 20 is a rear perspective view of a steering wheel according to a fourth embodiment of the present invention;

FIG. 21 is an enlarged view of the right half of the steering wheel;

FIG. 22 is a sectional view taken along line III-III of FIG. 21;

FIG. 23 is a sectional view taken along line IV-IV of FIG. 21;

FIG. 24 is a sectional view taken along line V-V of FIG. 21;

FIG. 25 is a sectional view of a steering wheel according to a fifth embodiment of the present invention;

FIG. 26 is a diagram illustrating different modes of head-up display associated with a steering wheel according to the present invention;

FIG. 27 shows a steering wheel according to a first modified embodiment of the present invention;

FIG. 28 shows a steering wheel according to a second modified embodiment of the present invention;

FIG. 29 shows a steering wheel according to a third modified embodiment of the present invention;

FIG. 30 shows a steering wheel according to a fourth modified embodiment of the present invention;

FIG. 31 shows a steering wheel according to a fifth modified embodiment of the present invention;

FIG. 32 shows a steering wheel according to a sixth modified embodiment of the present invention;

FIG. 33 shows a steering wheel according to a seventh modified embodiment of the present invention;

FIG. 34 shows a steering wheel according to an eighth modified embodiment of the present invention;

FIG. 35 shows a steering wheel according to a ninth modified embodiment of the present invention;

FIG. 36 is an enlarged view of a spoke portion of the steering wheel of the ninth modified embodiment;

FIG. 37 is an enlarged view of a spoke part of a steering wheel according to a tenth modified embodiment of the present invention;

FIG. 38 shows a steering wheel according to an eleventh modified embodiment of the present invention;

FIG. 39 shows a steering wheel according to a twelfth modified embodiment of the present invention;

FIG. 40 shows a steering wheel according to a thirteenth modified embodiment of the present invention;

FIG. 41 shows a steering wheel according to a fourteenth modified embodiment of the present invention;

FIG. 42 is a sectional view taken along line XLII-XLII of FIG. 41;

FIG. 43 is a rear perspective view of a steering wheel according to a fifteenth modified embodiment of the present invention;

FIG. 44 is a front perspective of the steering wheel of the fifteenth modified embodiment;

FIG. 45 shows an example of input operation applied to the steering wheel of the fifteenth modified embodiment; and

FIG. 46 shows another example of input operation applied to the steering wheel of the fifteenth modified embodiment.

### DESCRIPTION OF THE PREFERRED EMBODIMENT(S)

An input device according to the present invention will be described in the following with reference to the appended drawings.

### First Embodiment

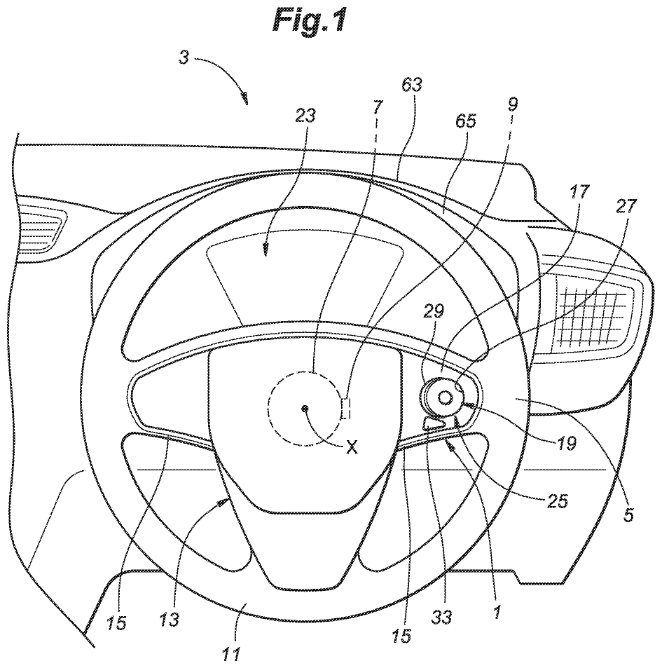

The input device 1 according to a first embodiment of the present invention is provided on a steering wheel 5 of a four-wheeled vehicle 3. FIG. 1 shows the case where the input device 1 is provided on the steering wheel 5 of a vehicle in which the driver's seat is located on the right hand side of the vehicle (right-side driving vehicle).

The steering wheel 5 is fixed to a steering shaft 7 provided in front of the driver's seat. The steering shaft 7 is rotatably retained by a steering column (not shown in the drawings) provided in front of the driver's seat. Thus, the steering wheel 5 is supported by the vehicle body so as to be rotatable around a rotational axis X of the steering shaft 7. The steering shaft 7 is provided with a steering angle sensor 9 for detecting the rotational angle thereof.

The steering wheel 5 includes a rim 11 configured to be gripped by the driver, a hub 13 connected to the steering shaft 7, and a spoke 15 radially extending from the hub 13 and connected to the rim 11.

The rim 11 has an annular shape centered on the rotational axis X (or the steering axis) of the steering shaft 7 and defines the outer edge of the steering wheel 5. When the driver turns the rim 11 about the rotational axis X, the steering angle of the road wheels is changed according to the rotational angle (or the steering angle). Thus, the rim 11 functions as a grip portion configured to be gripped by the driver who performs a steering input operation, and the steering wheel 5 functions as a steering operation member that accepts steering-related operations from the driver.

The spoke 15 includes two parts extending away from the rotational axis X. When the steering angle is zero, the two parts of the spoke 15 extend in the lateral direction.

The input device 1 includes a plate-shaped base portion 17 defining the rear surface of the spoke 15, a switch unit 19 provided on the base portion 17, a processing device 21 and a display device 23.

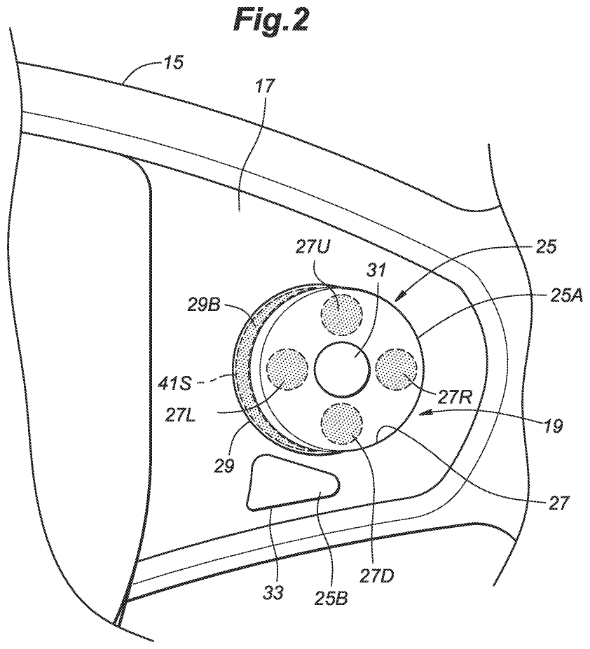

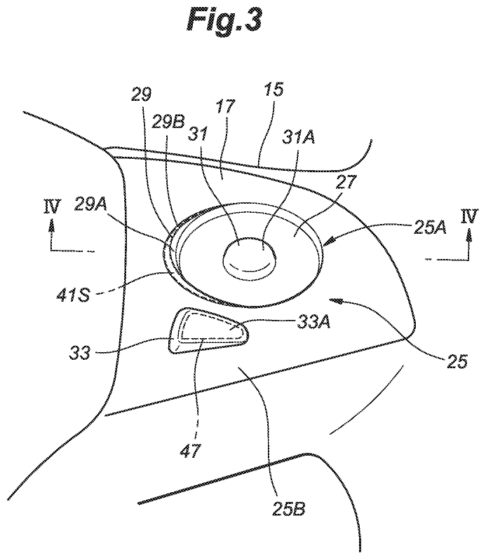

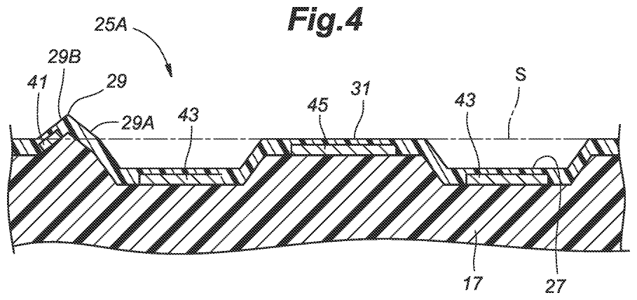

As shown in FIGS. 2 and 3, the base portion 17 is provided with an input operation portion 25 on which an input operation is performed by the driver. As shown in FIG. 1, the input operation portion 25 is positioned closer to the rotational axis than the rim 11, and the rim 11 is positioned closer to the outer edge than the input operation portion 25. The rear surface of the base portion 17 defines a flat surface except for the part where the input operation portion 25 is provided. The flat surface will be hereinafter referred to as a reference plane S (see FIG. 4).

In this embodiment, the input operation portion 25 provided on the base portion 17 consists of two parts which will be referred to as a first input operation portion 25A and a second input operation portion 25B.

As shown FIGS. 3 and 4, the first input operation portion 25A includes a recess 27 recessed with respect to the reference plane S and a rib 29 extending along a part of the edge of the recess 27.

The recess 27 is recessed with respect to the reference plane S, and has an arcuate peripheral edge when viewed from the front. A first protrusion 31 projects rearward from the center of the recess 27. The first protrusion 31 has a cylindrical shape.

As shown in FIG. 3, the rib 29 protrudes from the reference plane S and forms a narrow streak extending along the edge of the recess 27. The rib 29 has an arcuate shape extending along the edge of the recess 27 remote from the adjoining part of the rim 11 (grip portion) (or on the side of the rotational axis). As shown in FIG. 4, the rib 29 is provided with an inclined surface 29A located adjacent to the recess 27 and another inclined surface 29B located on the side remote from the recess 27 so that the rib 29 has a triangular shape in cross section. In this embodiment, the height and width of the rib 29 become progressively smaller toward the ends along the extending direction so that the rib 29 forms a crescent shape when viewed from the front.

The second input operation portion 25B includes a second protrusion 33 that protrudes from the reference plane S. In this embodiment, the second protrusion 33 has a substantially triangular prism shape. However, the shape of the second protrusion 33 is not limited to this example, but may also be a spherical crown shape, a spherical truncated shape, a rectangular parallelepiped shape, or a columnar shape.

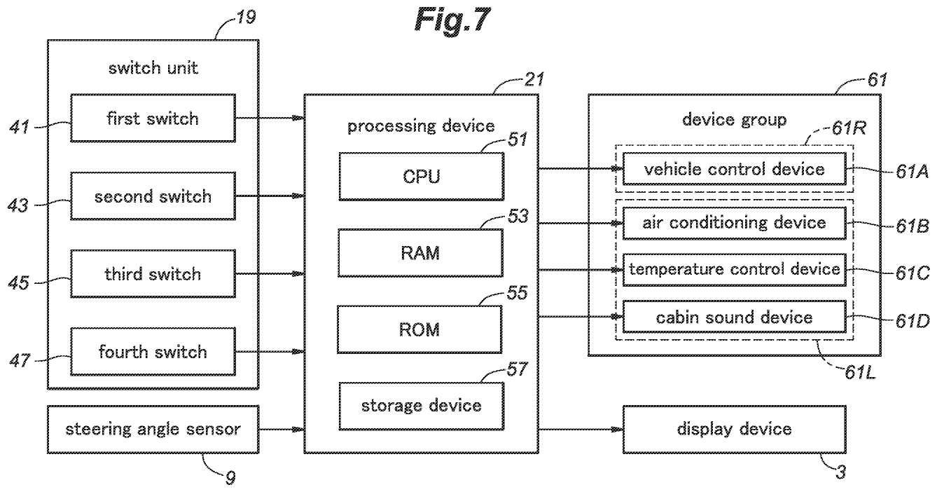

The switch unit 19 includes a plurality of switches which includes, as shown in FIG. 7, a first switch 41, a second switch 43, and a third switch 45 positioned on the rear surface of the first input operating portion 25A, and a fourth switch 47 positioned on the rear surface of the second input operation portion 25B. In this embodiment, the first switch 41, the second switch 43, the third switch 45, and the fourth switch 47 are each formed on a single sheet of transparent film. The first switch 41, the second switch 43, the third switch 45 and the fourth switch 47 are supported by the base portion 17 by the transparent film being attached to the rear surface of the base portion 17.

The first switch 41 is provided on the inclined surface 29B of the rib 29 on the side remote from the recess 27 and acquires the contact position of the user on the inclined surface 29B of the rib 29 on the side remote from the recess 27. FIG. 2 shows a detection area 41S of the first switch 41 for detecting a user touching the inclined surface 29B. The first switch 41 may include a plurality of a group of switches or a group of sensors arranged along the inclined surface 29B, or may include a group of switches or sensors arranged in a matrix over the inclined surface 29B. The sensors and the switches may be of the capacitance type or may be of the resistive film type.

The second switch 43 includes an annular detection portion 43A and a detection device 43B. The detection portion 43A detects a contact on the bottom surface of the recess 27 by the user. Based on the detection result of the detection portion 43A, the detection device 43B detects a swipe operation of the user on the bottom surface of the recess 27 either in clockwise or counterclockwise direction, and a touch operation on an upper end portion 27U, a lower end portion 27D, a left end portion 27L, and a right end portions 27R (see FIG. 2) of the bottom surface of the recess 27 that has persisted for a predetermined time or more.

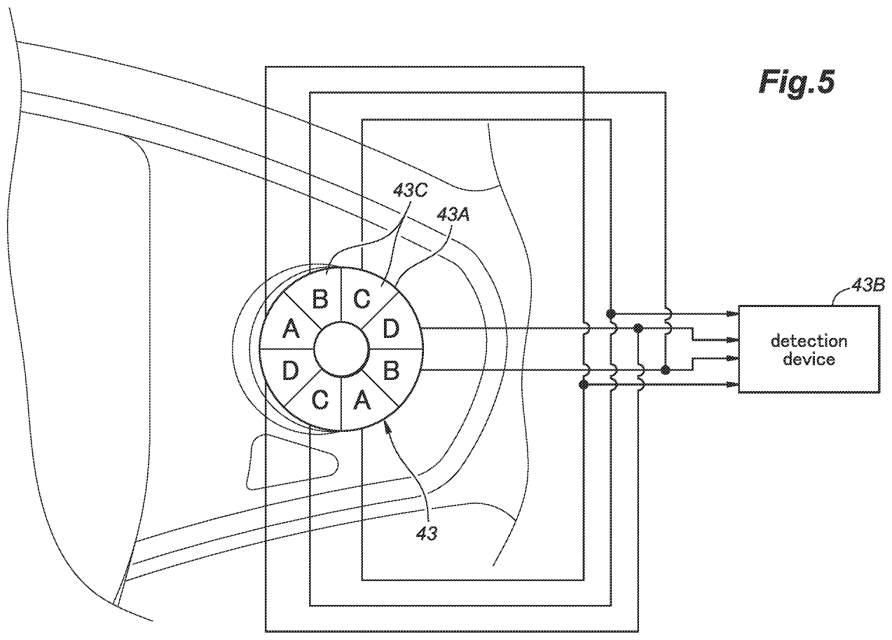

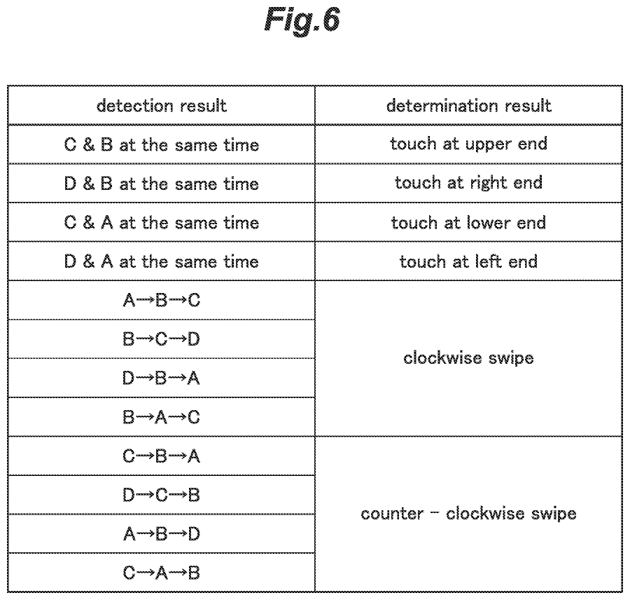

In this embodiment, as shown in FIG. 5, the detection portion 43A includes eight touch sensor sections 43C arranged at regular intervals in the circumferential direction. The touch sensor sections 43C may be of a capacitive type or of a resistive film type. The eight touch sensor sections 43C are circumferentially divided into four groups in the order of A, B, C, D, B, A, C, and D, and connected to the detection device 43B by wiring for each group. The detection device 43B is composed of a microcomputer having memory that stores a determination table shown in FIG. 6.

The detection device 43B determines that a swiping operation along the circumferential direction is performed when sequential contacts with three mutually adjoining sensor sections 43C are detected, and based on the table shown in FIG. 6, the direction of rotation is determined if the rotation is clockwise or counterclockwise.

When a simultaneous contact of two adjacent touch sensors 43C persisting for a predetermined period is detected, the detection device 43B determines that an upward, downward, leftward, or rightward input operation has been performed, and based on the table shown in FIG. 6, it is determined to which direction the touch operation corresponds. Touch operations on the upper end portion 27U, the lower end portion 27D, the left end portion 27L, and the right end portion 27R correspond to upward, downward, leftward, and rightward input operations, respectively.

In this manner, the second switch 43 can detect an input operation in the circumferential directions and an input operation in four directions, up, down, left, and right.

The third switch 45 detects a contact of the first protrusion 31 at the tip end surface 31A thereof. The third switch 45 may include a switch or sensor located on the tip end surface 31A. The switch or the sensor provided on the tip end surface 31A may be of the capacitive type or of the resistance film type.

The fourth switch 47 detects a contact of the second protrusion 33 at the tip end surface 33A thereof. The third switch 45 may include a switch or sensor located on the tip end surface 33A. The switch of the sensor provided on the tip end surface 33A may be of the capacitance type or of the resistance film type.

As shown in FIG. 7, the processing device 21 is composed of a microcomputer including a central processing unit (CPU 51), RAM 53, ROM 55, and a storage device 57 such as an HDD or SSD. The processing device 21 is connected to the first switch 41, the second switch 43, the third switch 45, the fourth switch 47, the steering angle sensor 9, the display device 23 and a group of various other devices 61. The processing device 21 is positioned in a front part of an instrument panel 63 and supported by the vehicle body. The group of devices 61 include, for example, a vehicle control device 61A, an air conditioner 61B, a temperature control device 61C, and a cabin sound device 61D.

The vehicle control device 61A executes an adaptive cruise control (ACC) to cause the own vehicle to follow the preceding vehicle at a prescribed vehicle-to-vehicle distance when the vehicle speed is lower than a predetermined value. The air conditioner 61B controls the temperature in the cabin to a set value. The temperature control device 61C controls the seat heater so that the temperature of the seat surface is maintained at a set value. The cabin sound device 61D outputs sound in the cabin at a volume corresponding to a set value. The set values of the group of devices 61 that are to be operated can be selected when the vehicle is stationary or when the vehicle is shipped from the factory.

The processing device 21 forwards the set values to the various devices included in the group of devices 61 based on the inputs from the switch unit 19 (the first switch 41, the second switch 43, the third switch 45, and the fourth switch 47). The processing device 21 stores various pieces of information including a conversion formula for converting the input to the switch unit 19 into the corresponding set values in the storage device 57.

The display device 23 is a device for displaying various kinds of information in the vehicle cabin, and in this embodiment, consists of a liquid crystal panel 65 provided on the instrument panel 63.

The processing device 21 constantly executes a change accepting operation for accepting changes in the set values of the various devices to be operated provided on the condition that the four-wheeled vehicle 3 is activated and the steering angle acquired by the steering angle sensor 9 is equal to or less than a predetermined threshold value. Details of the change accepting process will be described in the following.

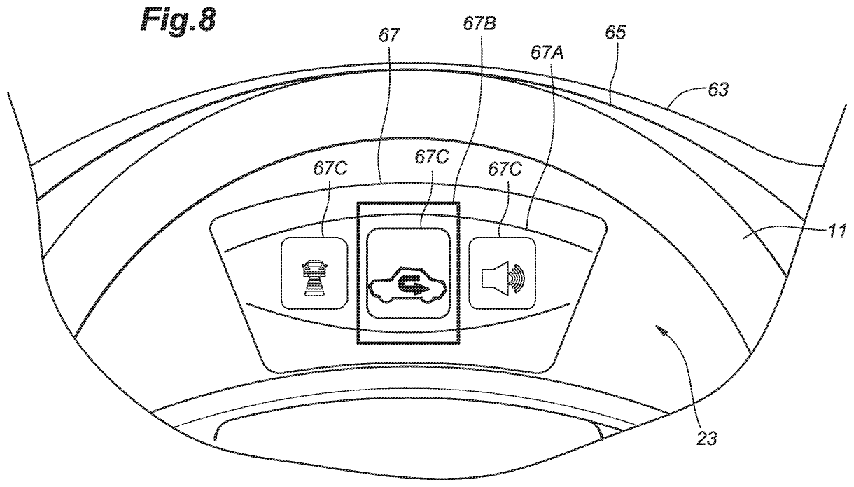

First, the processing device 21 determines if a contact is made to the left end portion 27L or the right end portion 27R of the recess 27 from the second switch 43. When the second switch 43 detects the user's contact to the left end portion 27L or the right end portion 27R of the recess 27, the processing device 21 displays an operation object setting screen 67 shown in FIG. 8. The operation object setting screen 67 includes a drum roll 67A and a selection frame 67B. Icons 67C corresponding to the different devices included in the group of devices 61 are displayed on the drum roll 67A, and one of the icons 67C on the drum roll 67A is displayed in the selection frame 67B.

The processing device 21 scrolls the icons 67C on the drum roll 67A such that the icons 67C are advanced by one step at a time every time the second switch 43 detects a contact at the left end portion 27L or the right end portion 27R of the recess 27. As a result, the icons 67C displayed in the selection frame 67B are sequentially changed according to the contact made to the left end portion 27L or the right end portion 27R of the recess 27.

Next, when the third switch 45 detects a contact to the first protrusion 31 at the tip end surface 31A thereof, the processing device 21 selects the device corresponding to the icon 67C displayed in the selection frame 67B as the device to be operated (hereinafter referred to as an operation object device).

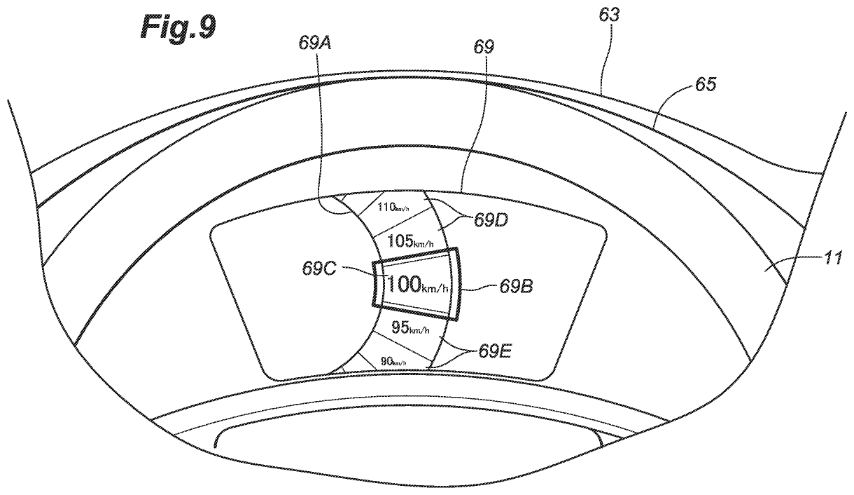

The processing device 21 further displays on the display device 23 a set value change screen 69 corresponding to the operation object device as shown in FIG. 9. The set value change screen 69 includes a drum roll 69A and a selection frame 69B. The drum roll 69A shows the current set value 69C of the device to be operated, and numerical values 69D obtained by incrementally increasing the set value by a predetermined unit (for example, 0.1, 1, 5, etc.) and numerical values 69E obtained by incrementally decreasing the set value by the predetermined unit. The numerical values 69D and 69E in the array of values displayed on the drum roll 69A are preferably arranged in ascending order. Immediately after the operation object device is set, the set value 69C of the operation object device at that time may be displayed in the selection frame 69B.

Thereafter, the processing device 21 scrolls the drum roll 69A so that the numerical value displayed in the selection frame 69B increases by one unit each time the second switch 43 detects a contact to the upper end portion 27U of the recess 27. Similarly, the processing device 21 scrolls the drum roll 69A so that the numerical value displayed in the selection frame 69B decreases by one unit each time the second switch 43 detects a contact to the lower end portion 27D of the recess 27.

Further, when the first switch 41 detects the user's contact to the inclined surface 29B, the processing device 21 acquires the displacement of the contact position until the contact is no longer detected, or the swipe amount. The processing device 21 converts the swipe amount into the amount of change in the set value based on a prescribed relationship (conversion formula) between the displacement amount of the contact position and the amount of change in the set value for each of the devices which is stored in the storage device 57 in advance. Next, the processing device 21 scrolls the drum roll 69A to match the amount of change of the set value. As a result, the numerical value displayed in the selection frame also changes according to the swipe amount.

The prescribed relationship may be set so that the amount of change in the set value is proportional to the amount of the displacement of the contact position. Further, when the first switch 41 detects the user's contact to the inclined surface 29B, the processing device 21 may acquire the moving speed of the contact position and calculate the amount of the change of the set value based on the moving speed. The prescribed relationship may be set so that the change amount of the set value is proportional to the moving speed of the contact position, and the prescribed relationship may also be set so that the ratio of the change amount to the moving speed decreases as the set value increases.

When the third switch 45 detects a contact to the tip end surface 31A of the first protrusion 31, the processing device 21 acquires the numerical value displayed in the selection frame 69B as an updated value. After that, the processing device 21 outputs the updated value to the operation object device, and ends the change accepting process. When the processing device 21 outputs the updated value to the operation object device, the set value of the operation object device is updated to the updated value outputted by the processing device 21.

Further, when the fourth switch 47 detects a contact to the tip end surface 33A of the second protrusion 33 during the change accepting process, the processing device 21 concludes the change accepting process.

Next, the effect of the input device 1 configured in this manner will be discussed in the following.

When driving a vehicle, the driver is required to pay attention to the situation around the vehicle. Therefore, it is desirable that the positions of the switches (the first switch 41, the second switch 43, the third switch 45, and the fourth switch 47) for performing the input operation can be recognized without visual recognition by the driver holding the rim 11.

The driver can recognize the position of the rib 29 by touching the base portion 17. As a result, the driver can swipe the surface of the rib 29 facing away from the recess 27 without looking. Therefore, the driver can easily perform the input operation to the first switch 41 even during driving operation.

The driver can recognize the position of the recess 27 by touching the base portion 17. Therefore, the driver can touch the upper end portion 27U, the lower end portion 27D, the left end portion 27L, and the right end portion 27R of the bottom surface of the recess 27 without looking. Therefore, the driver can easily operate the second switch 43 even during driving operation.

Also, the first switch 41 and the second switch 43 are provided closer to the rotational axis X than the rim 11. Therefore, the driver can easily perform input operations to the first switch 41 and the second switch 43 while gripping the rim 11 by hands.

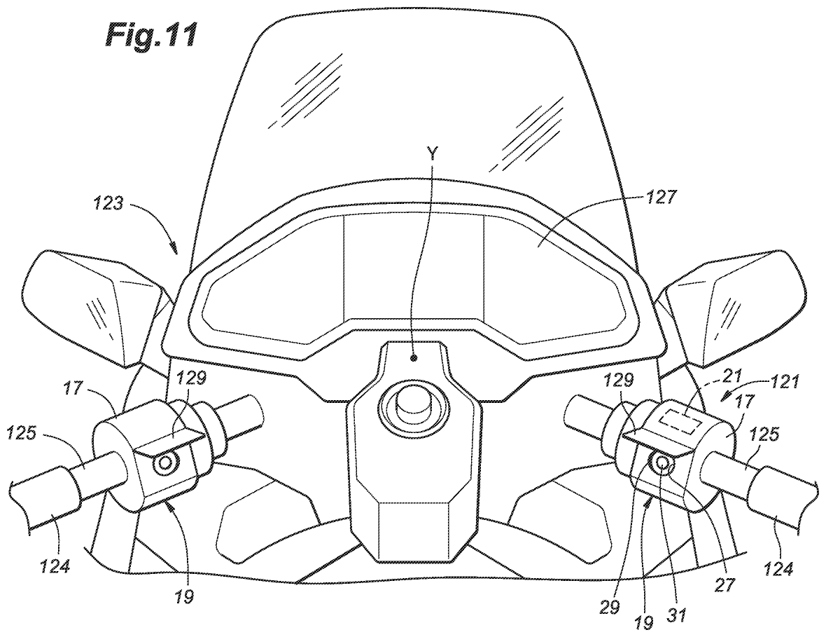

As shown in FIG. 2, the rib 29 has an arcuate shape, and the first switch 41 is located on the surface of the rib 29 facing away from the recess 27 or on the side of the rotational axis X, and is configured to detect a contact to this surface and the position of contact. Since the rib 29 has an arcuate shape, the surface of the rib 29 on the side facing away from the recess 27 also has an arcuate shape (or a crescent shape). As a result, as shown in FIG. 11, the contact range that is detected by the first switch 41 is formed so as to substantially follow the trajectory along which the thumb is moved with the remaining fingers hooked on the rim 11. The driver can rub the surface of the rib 29 facing away from the recess 27 by moving the thumb while gripping the rim 11, so that the first switch 41 can be easily operated.

When the driver is holding the steering wheel 5 to steer the four-wheeled vehicle 3, the driver may touch the first switch 41 or the second switch 43 unintentionally. In this embodiment, the processing device 21 executes the change accepting process when the steering angle acquired by the steering angle sensor 9 is equal to or less than a predetermined threshold value. More specifically, when the absolute value of the rotational angle (or the steering angle) of the steering wheel 5 is equal to or greater than the predetermined threshold value, the processing device 21 does not execute the change accepting process, and the output to the operation object based on the input to the first switch 41 and the second switch 43 is stopped. As a result, changes to the setting based on an erroneous input caused by the driver's unintentional touching of the first switch 41 or the second switch 43 during steering can be avoided.

### Second Embodiment

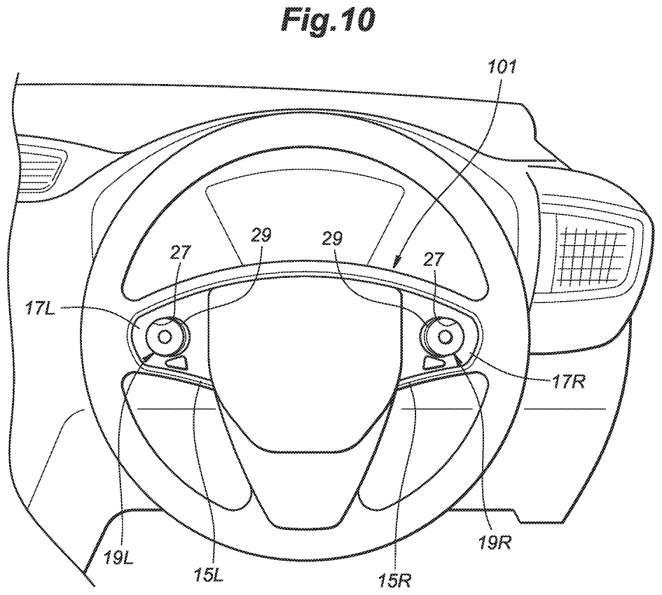

As shown in FIG. 10, the input device 101 according to the second embodiment of the present invention includes a spoke 15 consisting of a pair of parts, a base portion 17 consisting of a pair of parts provided on the respective parts of the spoke 15, and a pair of switch units 19 provided on the respective parts of the base portion 17, in addition to a processing device 21 and a display device 23. Hereinafter, with the steering angle at zero degrees, the right hand side part of the spoke 15 will be referred to as a right spoke part 15R, and the left hand side part of the spoke 15 as a left spoke part 15L,

The two parts of the base portion 17 provided on the left and right spoke parts 15 have a first input operation portion 25A and a second input operation portion 25B, respectively, and each operation portion is provided with a recess 27, a rib 29, a first protrusion 31, and a second protrusion. 33. The part of the base portion 17 provided on the left spoke part 15L and the other part of the base portion 17 provided on the right spoke part 15R are mirror-symmetrical to each other. Each recess 27 has a circular shape in front view, and each rib 29 has an arcuate shape extending along a part of the edge of the recess 27 adjacent to the rotational axis X (steering shaft).

Thus, the parts of the base portion 17 on the left and right spoke parts 15R and 15L are each provided with a switch unit 19. Hereinafter, the switch unit 19 provided on the right spoke part 15R may be referred to as a right switch unit 19R, and the switch unit 19 provided on the left spoke part 15L as a left switch unit 19L.

The right switch unit 19R and left switch unit 19L each include a first switch 41, a second switch 43, a third switch 45 and a fourth switch 47 similarly to that of the first embodiment. As in the first embodiment, the first switch 41 detects an input to the surface of the rib 29 facing away from the recess 27. A second switch 43 detects an input to the bottom surface of the recess 27. The third switch 45 detects a contact of the first protrusion 31 at the tip end surface 31A thereof, and the fourth switch 47 detects a contact to the second protrusion 33 at the tip end surface 33A thereof.

When the steering angle is less than a predetermined angle threshold value which is equal to or greater than 90 degrees (for example, 100 degrees), the processing device 21 acquires the set value for the device for the travel control of the vehicle in the device group 61 from the right switch unit 19R, and forwards the set value to the corresponding device (for example, the vehicle control device 61A of the first embodiment). Hereinafter, the part of the device group 61 that acquires the set value from the right switch unit 19R when the steering angle is less than the angle threshold value will be referred to as a first device group 61R (see FIG. 7).

When the steering angle is less than the angle threshold value, the processing device 21 acquires the set values of the devices included in the device group 61 other than those belonging to the first device group 61R (such as the air conditioner 61B, and the temperature control device 61C) from the left switch unit 19L. Hereinafter, the part of the devices in the device group 61 other than those belonging to the first device group 61R will be referred to as a second device group 61L.

When the steering angle is equal to or greater than the angle threshold value, the processing device 21 acquires the set values of the devices of the second device group 61L from the right switch unit 19R, and forwards the set values to the corresponding devices. When the steering angle is equal to or greater than the angle threshold value, the processing device 21 acquires the set values of the devices of the first device group 61R from the left switch unit 19L, and outputs them to the corresponding devices.

Next, the effect of the input device 101 configured in this manner will be discussed in the following. Since the driver can recognize the positions of the rib 29 and the recess 27 by touching the base portion 17, the driver can easily perform input operations to the first switch 41 and the second switch 43 even during driving operation.

The processing device 21 sets the operation objects of the right switch unit 19R to the devices of the first device group 61R when the steering angle is less than the angle threshold value, and to the devices of the second device group 61L when the steering angle is equal to or greater the angle threshold value. Similarly, the processing device 21 sets the operation objects of the left switch unit 19L to the devices of the second device group 61L when the steering angle is less than the angle threshold value, and to the devices of the first device group 61R when the steering angle is equal to or greater the angle threshold value. Thus, the processing device 21 switches the operation objects of the switch unit 19 between the first device group 61R and the second device group 61L according to the steering angle.

As a result, regardless of the steering angle, the switch unit 19 positioned on the right half of the steering wheel 5 accepts the setting inputs to the device group 61 (first device group 61R) related to vehicle control. As a result, regardless of the steering angle, the switch unit 19 located on the right side of the steering wheel 5 accepts setting inputs to the device group 61 relating to vehicle control. Therefore, it is possible to change the operation objects of the switch unit 19 so as to suit the perception of the driver who is accustomed to inputting the vehicle control set values in the switch unit 19 positioned on the right side.

### Third Embodiment

As opposed to the first and second embodiments, the input device 121 according to the third embodiment of the present invention is provided on a bar handle 125 which serves as a steering operation member of a two-wheeled vehicle 123 such as a motorcycle as shown in FIG. 11.

The input device 121 includes a base portion 17 consisting of two parts provided on the left and right bar handles 125, respectively, and a pair of switch units 19 provided on the respective parts of the base portion 17, in addition to a processing device 21 and a display device 23.

The left and right bar handles 125 are respectively provided with grips 124 which are configured to be gripped by the driver. The two parts of the base portion 17 are provided nearer to the axis Y (rotational axis Y) of the steering shaft than the grips 124 are.

The two parts of the base portion 17 are respectively provided with a first input operation portion 25A and a second input operation portion 25B, each provided with a recess 27, a rib 29 and a first protrusion 31. The part of the base portion 17 provided on the left bar handle 125 and the other part of the base portion 17 provided on the right bar handle 125 are mirror-symmetrical to each other. Each recess 27 has a circular shape in front view, and each rib 29 has an arcuate shape extending along a part of the edge of the recess 27 adjacent to the axis Y of the steering shaft.

The two parts of the base portion 17 of the left and right bar handles 125 are provided with the switch units 19, respectively. Each switch unit 19 comprises a first switch 41, a second switch 43 and a third switch 45. The first switch 41 detects a swipe operation applied to the rib 29, and the second switch 43 detects a swipe operation applied to the recess 27, and a touch operation applied to the upper end portion 27U, the lower end portion 27D, the left end portion 27L and the right end portion 27R of the bottom of the recess 27. The third switch 45 detects a contact to the first protrusion 31 at the tip end surface 31A thereof.

The first switch 41, the second switch 43, and the third switch 45 may be composed of capacitive touch switches, or may be composed of pressure-sensitive touch switches. However, in this embodiment, since the input device 121 is provided on the two-wheeled vehicle 123 which is often driven by a driver wearing gloves, the first switch 41, the second switch 43, and the third switch 45 are preferably composed of pressure-sensitive touch switches.

The switch unit 19 provided on the left bar handle 125 receives setting inputs for the seat temperature control device 61C, the driving mode selection, and the like. The switch unit 19 provided on the right bar handle 125 receives a setting input related to the upper limit speed of automatic cruise control (ACC). However, the set values to be received by the switch units 19 are not limited to those mentioned above, but may also be set values for selecting the height of the windshield and for the output of the air conditioner 61B among other possibilities. The display device 23 is preferably provided in a front part of the two-wheeled vehicle 123 and composed of a liquid crystal display panel 127 that displays a speedometer or the like.

Each part of the base portion 17 is provided with an eaves portion 129 that overhangs in the rearward direction above the first input operation portion 25A or the second input operation portion 25B. The eaves portions 129 cover the first input operation portion 25A and the second input operation portion 25B, respectively, from above. The eaves portions 129 are each preferably made of a plate member made of resin, and may have some translucency.

Next, the effect of the input device 121 configured in this manner will be discussed in the following. Since the driver can recognize the positions of the ribs 29 and the recesses 27 by touching the base portion 17, the driver can easily perform input operations to the first switches 41 and the second switches 43 even during driving operation.

Each part of the base portion 17 is provided with the eaves portion 129 that covers the first input operation portion 25A or the second input operation portion 25B from above. By providing the eaves portions 129, the first switches 41, the second switches 43, the third switches 45, and the fourth switches 47 are covered from above by the corresponding eaves portions 129. Thus, the eaves portions 129 function as a cover that protects the first switches 41, the second switches 43, the third switches 45 and the fourth switches 47. More specifically, for example, the eaves portions 129 prevent rainwater from entering the first switches 41, the second switches 43, the third switches 45, and the fourth switches 47. In addition, since direct sunlight can be prevented from hitting the first switches 41, the second switches 43, the third switches 45, and the fourth switches 47 by providing the eaves portions 129, the visibility of the input operation portions 25 is improved. and an erroneous input can be prevented.

### Modified Embodiments of First to Third Embodiments

In the first to third embodiments, the input devices 1, 101, 121 were provided on the steering operation members (steering wheel 5, steering bar 125) of four-wheeled and two-wheeled vehicles, but the present invention is not limited to these examples. The input device 1 may be applied to operating members configured to be gripped by a user for any other operations. The input device 1 is applicable to members and devices which are positioned so as not to be readily visible to the user,

The input device 1 may be provided on a vehicle seat, for example. In such a case, the switch unit 19 preferably receives inputs of set values for the slide position and the reclining angle of the seat. At this time, the rib 29 may be provided, for example, on the bottom surface of the seat cushion so as to extend in the fore and aft direction. Accordingly, when the seated person puts his or her hand from a laterally outer side of the seat cushion to the bottom side of the seat cushion, the position of the rib 29 can be easily recognized. Alternatively, the input device 1 may be provided on the door lining. Also at this time, the rib 29 is preferably provided so as to extend in the fore and aft direction.

In the first to third embodiments mentioned above, by swiping to the inclined surface 29B of the rib 29, the set values of the vehicle control device 61A, the air conditioner 61B, the temperature control device 61C, and the cabin sound device 61D were changed by swiping the inclined surface 29B of the rib 29, but other configurations are possible. The input device 1 may be configured such that, for example, selection of music output from the cabin sound device 61D and adjustment of the air flow rate of the air conditioner 61B are changed by swiping the inclined surface 29B of the rib 29.

In the first to third embodiments mentioned above, the first switch 41 was configured to acquire the contact position on the surface of the rib 29 facing away from the recess 27, but the area from which the first switch 41 acquires the contact position may include a part or all of the tip end portion of the rib 29 or the surface of the rib 29 facing away from the recess 27, instead of the surface of the rib 29 facing away from the recess 27.

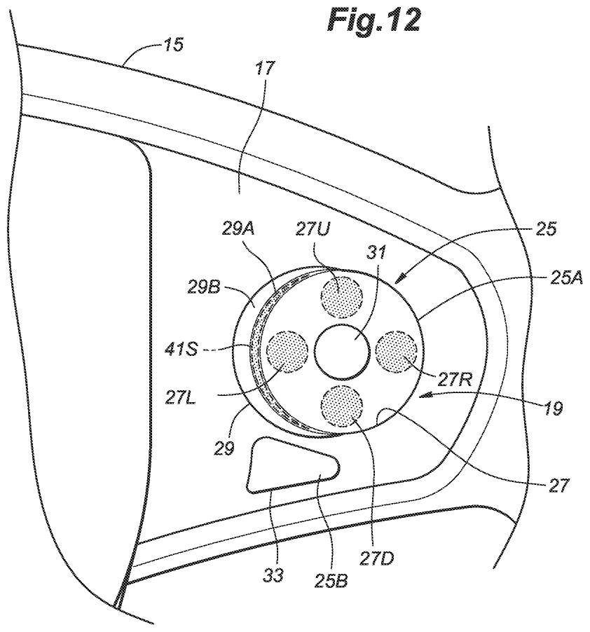

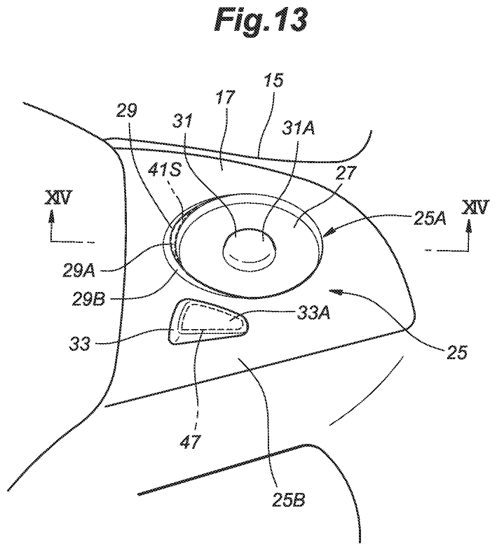

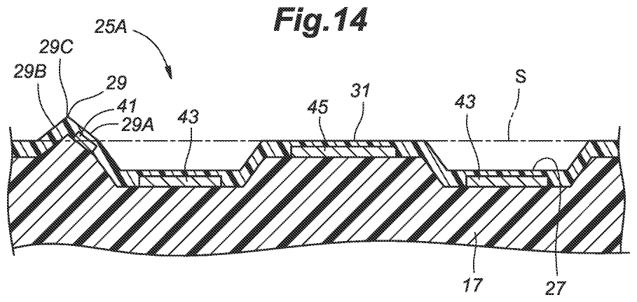

Further, as shown in FIGS. 12, 13, and 14, the contact detection area 41S of the first switch 41 may be provided on the inclined surface 29A of the rib 29 adjacent to the recess 27. As a result, even when the input device 1, 101 is provided on a large steering wheel 5 of a bus, truck, or the like, the driver can easily perform an input operation to the detection area 41S. In addition, the driver can touch or swipe the bottom surface of the recess 27 (to perform an input operation to the second switch 43) and swipe the detection area 41S (input operation to the first switch 41) in a selective manner without requiring to move the finger over the top portion 29C (see FIG. 14) of the rib 29. The convenience of the input devices 1, 101, and 121 is thereby enhanced.

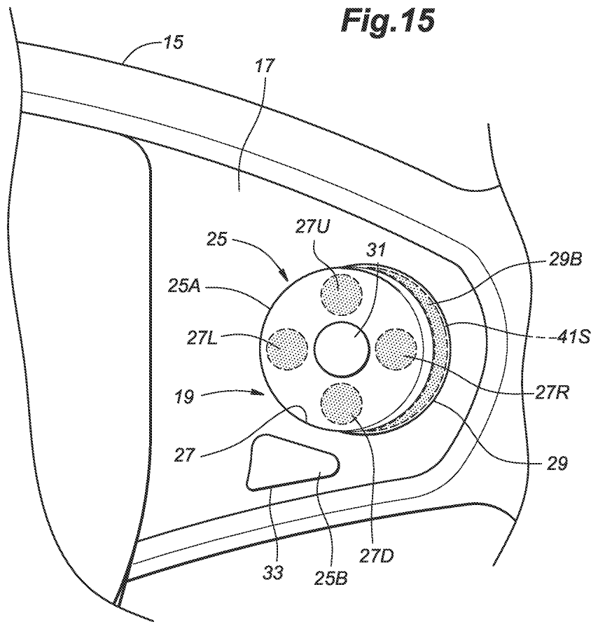

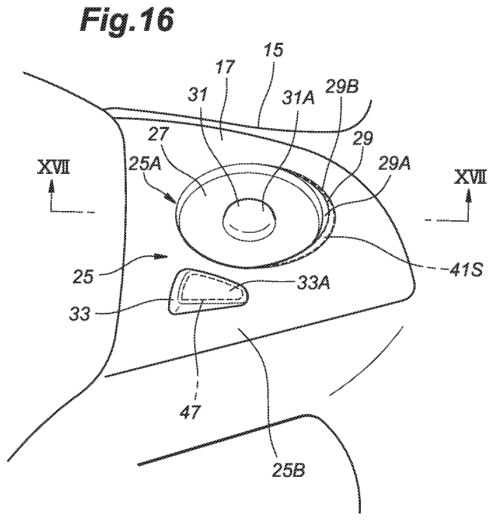

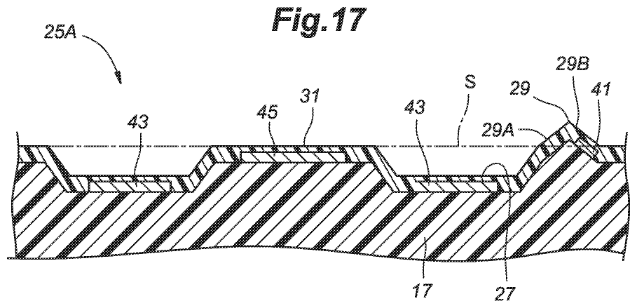

In the first to third embodiments, the rib 29 was provided so as to extend along the edge of the recess 27 adjacent to the rotational axis X, but the present invention is not limited to this configuration. For example, as shown in FIGS. 15, 16, and 17, the rib 29 may be provided on the side of the recess 27 remote from the rotational axis X, or on the side of the rim 11 (the side of the grip portion). In this case as well, the user contact detection area 41S of the first switch 41 may be provided on the inclined surface 29B of the rib 29 either on the side facing away from the recess 27, or on the side adjacent or the recess 27. When the rib 29 is provided on the edge of the recess 27 adjacent to the rim 11, even when the input device 1, 101 is provided on a large steering wheel 5, the finger of the driver gripping the rim 11 is able to reach the rib 29 with ease, and the input operation is facilitated. In addition, the extending direction of the rib 29 differs from the trajectory of the natural movement of the finger of the driver who grips the rim 11, as compared to the case where the rib 29 is provided on the side adjacent to the rotational axis X, an unintended erroneous input by the driver can be prevented.

In the first to third embodiments mentioned above, the icons 67C were displayed on the drum roll 67A shown on the display device 23 when the driver touches the left end portion 27L or the right end portion 27R of the bottom surface of the recess 27, but the present invention is not limited to this configuration. Device names may be printed on the drum roll 67A, instead of the icons 67C.

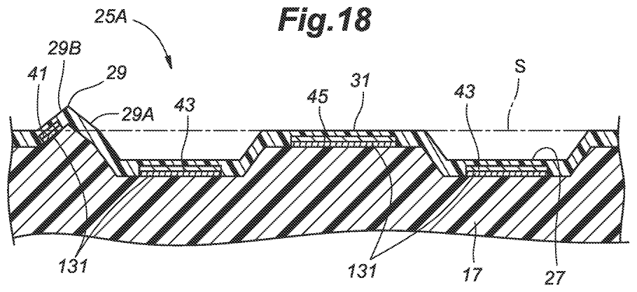

As shown in FIG. 18, a haptic device 131 may be provided behind (on the side of the base portion 17) each of the first switch 41, the second switch 43, the third switch 45 so that when a touch operation is applied to the corresponding switch, a pushback force opposing the touch operation may be applied to the finger of the user.

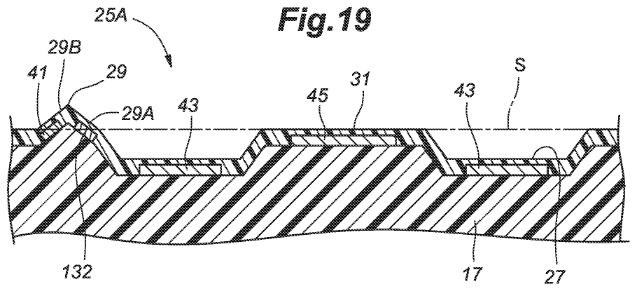

Further, as shown in FIG. 19, the haptic device 132 may be provided so as to extend along the surface of the rib 29 on the side adjacent to the recess 27. The haptic device 132 (tactile device) provides a tactile feedback to the user's finger touching the rib 29. The haptic device 132 may consist of any per se known device that provides a tactile feedback to the user's finger by applying vibrations. By providing the haptic device 132 on the surface of the rib 29 on the side adjacent to the recess 27, the positioning of the haptic device 132 can be facilitated because the haptic device 132 does not to overlap with the first switch 41. In addition, since the haptic device 132 can be positioned so as to be directly touched by the finger of the user touching the rib 29, an accurate tactile feedback can be applied to the user over the area extending along the length of the rib 29.

### Fourth Embodiment

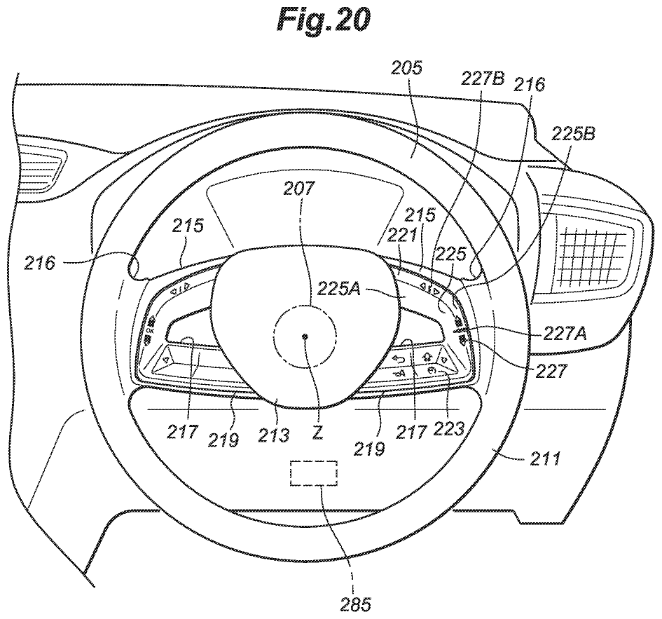

A steering wheel 205 according to the fourth embodiment of the present invention is provided in front of the driver's seat. The following description will be based on the case where the driver's seat is located on the right hand side of the vehicle (so-called right-hand drive) as shown in FIG. 20, but the present invention is not limited to this positioning of the driver's seat.

As shown in FIG. 20, the steering wheel 205 is connected to a steering shaft 207 provided in front of the driver's seat. The steering shaft 207 is provided in front of the driver's seat and is rotatably held by a steering column (not shown in the drawings) supported by the vehicle body. As a result, the steering wheel 205 is rotatably supported by the vehicle body about the axis Z of the steering shaft 207. The axis Z extends linearly and obliquely upward toward the rear of the vehicle body.

The steering wheel 205 includes a rim 211 (grip portion) configured to be gripped by the driver, a hub 213 (hub portion) connected to the steering shaft 207, and a spoke 215 (spoke portion) extending radially from the hub 213 and connected to the rim 211.

The rim 211 has an annular shape centered on the axis Z (i.e., steering axis) of the steering shaft 207 and defines the outer edge of the steering shaft 207. The rim 211 functions as a grip configured to be gripped by the driver for steering input. When the driver rotates the rim 211 around the axis Z, the steering angle of the road wheels is changed according to the rotational angle (that is, the steering angle). Thus, the rim 211 functions as a grip portion gripped by the driver who makes a steering input, and the steering wheel 205 functions as a steering operation member that receives steering-related operations from the driver.

A spoke 215 consisting of two parts is provided in the steering wheel 205. The two parts of the spoke 215 are connected at the proximal ends thereof to the hub 213, extend away from axis Z, and are connected to the radially inner surface of rim 211 at the free ends thereof. When the steering angle is zero, the spoke 215 generally extends in the lateral direction.

An upper edge part of the part of the spoke 215 adjacent to the rim 211 is provided with a rim recess 216 which is recessed radially outward and downward. The rim recess 216 is shaped and dimensioned so as to conform to the thumb of the driver so that the driver can hook his or her thumb on the rim recess 216.

In this embodiment, the base ends (radial inner ends) of the two parts of the spoke 215 are each bifurcated and connected to the hub 213 at the respective bifurcated ends thereof. Thus, the spoke 215 is provided with a pair of spoke through-holes 217 that are passed through the spoke 215 in the fore and aft direction. The configuration of the spoke 215 will be described in more detail in the following with respect to the case where the steering angle is zero.

### <Structure of Steering Switch>

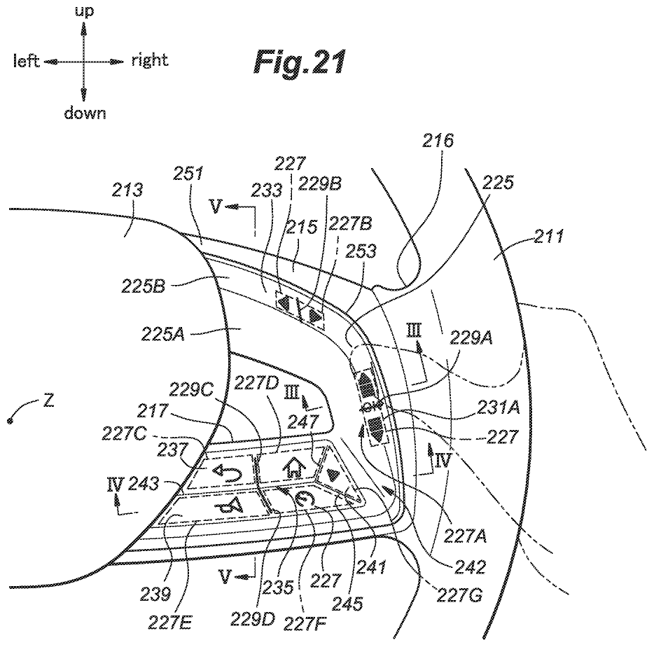

As shown in FIGS. 20 and 21, the spoke 215 (spoke parts) is provided with steering switches 219 on the rear surface thereof for accepting input operations from the driver. Since the left and right parts of the spoke 215 are generally symmetrical to each other, the following description will be directed only to the right part of the spoke 215.

Hereinafter, the direction directed toward the front side of the vehicle body along the axis Z of the steering shaft 207 will be referred to as the front side, and the direction toward the rear side of the vehicle body will be referred to as the rear side. Further, the directions perpendicular to the axis Z are defined as the left direction, the right direction, the upper direction, and the lower direction, respectively. However, this definition is for the convenience of explanation, and the present invention should not be limited by this definition.

The steering switch 219 is provided with a peripheral edge portion 221 extending along the upper and right edges (edges away from the axis Z) of the spoke through-hole 217 and a lower edge portion 223 extending along the lower edge of the spoke through-hole 217. The rear surfaces of the peripheral edge portion 221 and the lower edge portion 223 jointly form the rear surface of the spoke 215.

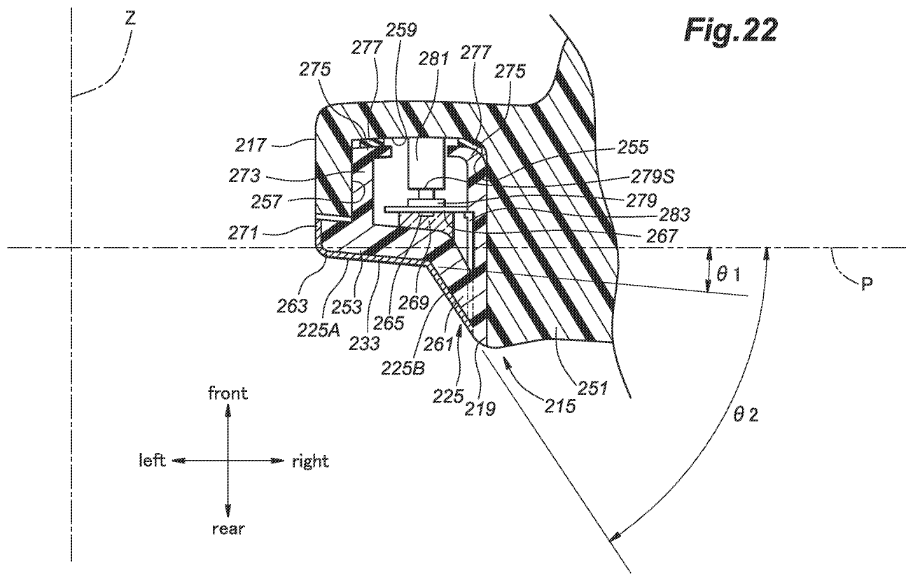

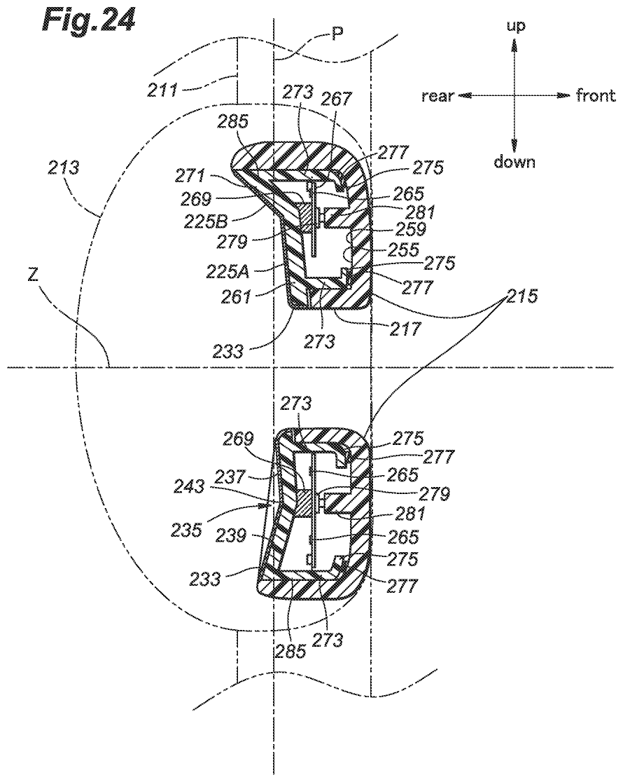

The rear surface of the peripheral edge portion 221 is provided with an inclined surface 225 inclined with respect to an imaginary plane P (see FIGS. 22, 23, and 24) perpendicular to the axis Z of the steering shaft 207. As shown in FIG. 21, the inclined surface 225 surrounds the spoke through-hole 217 in a spaced apart manner. The inclined surface 225 is inclined forward as one moved radially inward or toward the Z axis.

The inclined surface 225 includes a first inclined surface 225A extending along the outer edge of the spoke through-holes 217 and a second inclined surface 225B extending along the outer edge of the first inclined surface 225A (the edge remote from the spoke through-hole 217). The first inclined surface 225A and the second inclined surface 225B are both inclined with respect to the imaginary plane P perpendicular to the axis Z of the steering shaft 207. As shown in FIG. 22, the inclination angle θ2 of the second inclined surface 225B with respect to the imaginary plane P is greater than the inclination angle θ1 of the first inclined surface 225A with respect to the imaginary plane P.

As shown in FIGS. 20 and 21, the peripheral edge portion 221 is provided with a pair of accepting portions 227 configured to accept input operations from the driver. One of the accepting portions 227 (hereinafter referred to as a first accepting portion 227A) extends substantially vertically in front view along the radially outer side edge of the peripheral edge portion 221. The other accepting portion 227 (hereinafter referred to as a second accepting portion 227B) extends along the upper edge of the peripheral edge portion 221 substantially in the horizontal direction when viewed from the front. The first accepting portion 227A and the second accepting portion 227B are each positioned on the second inclined surface 225B.

The first accepting portion 227A is provided with a first rib 229A, and the second accepting portion 227B is provided with a second rib 229B. Each of the first rib 229A and the second rib 229B protrudes rearward from the rear surface (in particular, the inclined surface 225) of the spoke 215 and forms a streak shape (rib shape) extending in a predetermined direction. The first rib 229A and the second rib 229B are located centrally in the areas for detecting the input operation of the first accepting portion 227A and the second accepting portion 227B (hereinafter, the detection area, see the broken line portions in FIG. 21), respectively. The extending direction of the first rib 229A is orthogonal to the extending direction of the first accepting portion 227A. The first rib 229A and the second rib 229B both extend along the inclined surface 225. In this embodiment, the first rib 229A and the second rib 229B both extend along the second inclined surface 225B.

The extending direction of the first rib 229A and the extending direction of the second rib 229B are different from each other. More specifically, the first rib 229A extends toward the axis Z of the steering shaft 207 as one moves downward. The second rib 229B extends away from the axis Z of the steering shaft 207 as one moves downward.

The first accepting portion 227A generally extends vertically on the radially outer edge of the spoke 215. The first accepting portion 227A extends downward from a vertically central part of the rim 211 in the vertical direction with a certain inclination toward the rim 211. The extending direction of the first accepting portion 227A generally intersects the extending direction of the first rib 229A. The first accepting portion 227A acquires the operation amount (swipe amount) related to the driver's swipe operation (also referred to as scroll operation or tracing operation) in the extending direction, or in the direction intersecting the first rib 229A. The first accepting portion 227A may overlap with the first rib 229A at a central part thereof with respect to the extending direction thereof.

The second accepting portion 227B extends generally radially (lateral direction) with respect to the axis Z at an upper edge part of the rear surface of the spoke 215. The second accepting portion 227B intersects the second rib 229B. The second accepting portion 227B acquires the position at which a touch input is made by the driver, and accepts the input operation related to a left/right selection, or a binary selection according to the acquired position. The second accepting portion 227B overlaps the second rib 229B at the substantially central part thereof with respect to the extending direction thereof, and accepts an input operation for the selection of left or right based on if the input is made to the left or right of the second rib 229B.

As shown in FIG. 21, the second accepting portion 227B is located above the first accepting portion 227A and below the rim recess 216. Also, the second accepting portion 227B is provided at a position closer to the hub 213 than the first accepting portion 227A. In addition, the detection area of the second accepting portion 227B may be separated into two parts (for example, the portions indicated by the two triangles in FIG. 21) located on the left and right sides of the second rib 229B, and the input operation regarding the selection of left and right may be accepted according to which of the two parts the input operation is made.

The first accepting portion 227A and the second accepting portion 227B each consist of a single touch sensor 233 (or a plurality of touch sensors) provided on the rear surface of the steering switch 219 as a sheet-like member, and configured to acquire the position at which the contact (touch) by the driver is detected. The touch sensor 233 is positioned so as to cover the rear surface of the peripheral edge portion 221 and the lower edge portion 223.

The touch sensor 233 acquires the contact (touch) position (proximity position) of the driver in the detection areas corresponding to the first accepting portion 227A and the second accepting portion 227B. Furthermore, the touch sensor 233 can acquire the swipe amount (the amount of tracing or scrolling) based on the time change of the contact position (or proximity position) within the detection area.

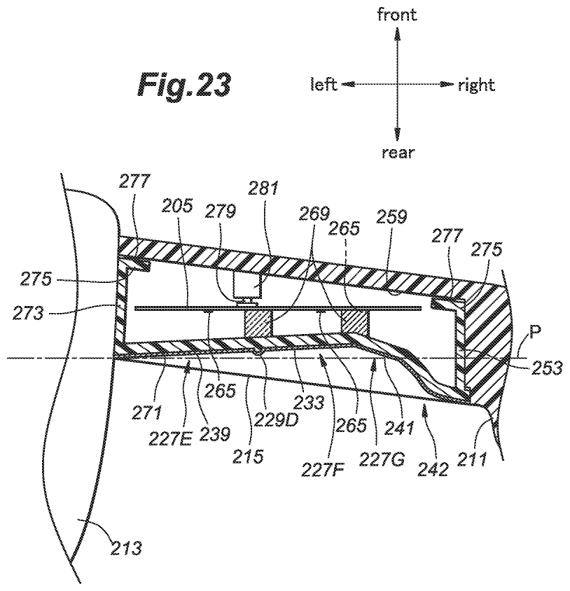

The lower edge portion 223 is provided with a spoke recess 235 which is recessed forward. As shown in FIG. 23, the spoke recess 235 is recessed forward with respect to the imaginary plane P. At least one accepting portion 227 is provided in the spoke recess 235. The accepting portion 227 provided in the spoke recess 235 accepts an input operation from the driver, in particularly a touching operation by the driver. In this embodiment, the accepting portion 227 provided in the spoke recess 235 is configured to accept a pressing operation from the driver as well. In this embodiment, five accepting portions 227 are provided in the spoke recess 235.

The spoke recess 235 is defined by three surfaces: a first surface 237, a second surface 239 and a third surface 241. The first surface 237, the second surface 239, and the third surface 241 are substantially flat surfaces with different inclination angles. A stepped portion 242 (see FIGS. 22 and 23) is provided on the right edge of the spoke recess 235, or on the right edge of the third surface 241.

The first surface 237 is inclined rearward and radially outward (with respect to the axis Z) as one moves downward.

The second surface 239 is provided below the first surface 237. The second surface 239 is connected to the bottom edge of the first surface 237. The second surface 239 is inclined forward and radially outward with respect to the axis Z as one moves upward. The angle formed between the first surface 237 and the second surface 239 is set to be 90 degrees or greater.

The third surface 241 is provided on the side of the first surface 237 and the second surface 239 remote from the axis Z of the steering shaft 207. The third surface 241 is connected to the radially outer edge of the first surface 237 (the edge remote from the axis Z) and the radially outer edge of the second surface 239. The third surface 241 is inclined rearward as one moves radially outward with respect to the Z axis.

A first ridge 243 (edge) is formed between the first surface 237 and the second surface 239. The first ridge 243 is a line of intersection between the first surface 237 and the second surface 239, and connects the first surface 237 and the second surface 239 to each other. A second ridge 245 (edge) is formed between the second surface 239 and the third surface 241. The second ridge 245 is a line of intersection between the second surface 239 and the third surface 241, and connects the second surface 239 and the third surface 241 to each other. A third ridge 247 (edge) is formed between the third surface 241 and the first surface 237. The third ridge 247 is a line of intersection between the third surface 241 and the first surface 237, and connects the third surface 241 and the first surface 237 to each other.

The second ridge 245 between the second surface 239 and the third surface 241 is inclined rearward and downward as one moves away from the axis Z (radially outward). The angle formed by the first ridge 243 and the second ridge 245, the angle formed by the second ridge 245 and the third ridge 247, and the angle formed by the third ridge 247 and the first ridge 243 are all set to be 90 degrees or greater.

The first surface 237 is provided with a third rib 229C that protrudes rearward and extends substantially in the vertical direction. The third rib 229C divides the first surface 237 into two parts, a part close to the axis Z (radially inner side) and another part remote from the axis Z (radially outer side). The accepting portion 227 is distributed between the two divided parts of the first surface 237. Hereinafter, the part of the accepting portion 227 provided on the radially inner side of the third rib 229C of the first surface 237 will be referred to as a third accepting portion 227C, and the part of the accepting portion 227 provided on the radially outer side will be referred to as a fourth accepting portion 227D.

The third accepting portion 227C accepts a driver's input to a part of the first surface 237 radially inward of the third rib 229C. The third accepting portion 227C is formed by a touch sensor 233 that is common to that forming the first accepting portion 227A and the second accepting portion 227B. The touch sensor 233 can detect a touch input to a part of the first surface 237 radially inward of the third rib 229C (see broken line in FIG. 21).

The fourth accepting portion 227D receives a driver's input to a part of the first surface 237 radially outward of the third rib 229C. The fourth accepting portion 227D is formed by a touch sensor 233 that is similar to those of the first accepting portion 227A and the second accepting portion 227B. The touch sensor 233 can detect a touch input to a part of the first surface 237 radially outward of the third rib 229C (see broken line in FIG. 21).

The second surface 239 is provided with a fourth rib 229D that protrudes rearward and extends substantially in the vertical direction. The fourth rib 229D divides the second surface 239 into two parts, a part close to the axis Z (radially inner side) and another side remote from the axis Z (radially outer side). The accepting portion 227 is distributed between the two divided parts of the second surface 239. Hereinafter, the part of the accepting portion 227 provided on the part of the second surface 239 radially inward of the fourth rib 229D will be referred to as a fifth accepting portion 227E, and the part of the accepting portion 227 provided radially outward of the fourth rib 229D will be referred to as a sixth accepting portion 227F.

The fifth accepting portion 227E receives a driver's input to a part of the second surface 239 radially inward of the fourth rib 229D. The fifth accepting portion 227E is formed by a touch sensor 233 that is similar to those of the first accepting portion 227A and the second accepting portion 227B. The touch sensor 233 can detect a touch input to a part of the second surface 239 radially inward of the fourth rib 229D (see broken line in FIG. 21).

The sixth accepting portion 227F receives a driver's input to a part of the second surface 239 radially outward of the fourth rib 229D. The sixth accepting portion 227F is formed by a touch sensor 233 that is similar to those of the first accepting portion 227A and the second accepting portion 227B. The touch sensor 233 can detect a touch input to a part of the second surface 239 radially outward of the fourth rib 229D (see broken line in FIG. 21).

The third surface 241 is provided with a single accepting portion 227 (hereinafter referred to as a seventh accepting portion 227G). The seventh accepting portion 227G accepts the driver's input to the third surface 241. The seventh accepting portion 227G is formed by a touch sensor 233 similar to those of the first accepting portion 227A and the second accepting portion 227B. The touch sensor 233 can detect a touch input to the third surface 241 (see broken line in FIG. 21).

Each of the first accepting portion 227A to the seventh accepting portion 227G may be configured to accept an input consisting of a pressing operation (or pushing operation) in addition to the driver's swipe or touch operation on the corresponding surface or part defining the spoke recess 235. Further, the third accepting portion 227C to the seventh accepting portion 227G respectively accept inputs related to the selection operation of the operation object corresponding to the input operation accepted by the first accepting portion 227A and the second accepting portion 227B.

For example, the third accepting portion 227C stops the input operation from the first accepting portion 227A and the second accepting portion 227B, and accepts the input operation for selecting the corresponding operation object. The fourth accepting portion 227D accepts an input operation for restoring the state before the input operations were started. The fifth accepting portion 227E accepts an input operation related to a horn. The sixth accepting portion 227F accepts an input operation related to various meters. For example, the sixth accepting portion 227F may accept an input operation related to changing the display mode of the meter panel located in front of the driver.

The seventh accepting portion 227G accepts an input operation for the turn signal. For example, when the driver presses the seventh accepting portion 227G provided on the right part of the spoke 215, the right direction indicator blinks. When the driver presses the seventh accepting portion 227G provided on the left part of the spoke 215, the left direction indicator blinks.

In this embodiment, the seventh accepting portion 227G is configured to receive both a touch operation and a pressing operation from the driver. Therefore, for example, when only a touch operation is inputted to the seventh accepting portion 227G, a three-flash turn signal that blinks a predetermined number of times (for example, three times) may be activated. On the other hand, when both a touch operation and a pressing operation are inputted to the seventh accepting portion 227G, the direction indicator starts continuously blinking until the vehicle completes the turn. As a result, the seventh accepting portion 227G enables operations similar to those of a conventional lever switch or a turn signal lever for operating the turn signal.

### <Spoke Structure>

Next, the details of the structure of the spoke 215 will be described in the following. As shown in FIG. 21, each part of the spoke 215 includes a spoke body 251 connecting the hub 213 and the rim 211 to each other and a switch unit 253 (steering switch unit) provided on the spoke body 251.

The spoke body 251 is connected to the hub 213 at the base end thereof and extends radially outward in the lateral direction from the axis Z. The free end of the spoke body 251 is connected to a radially inner part of the rim 211. In this embodiment, the spoke body 251 is bifurcated toward the base end part thereof.

As shown in FIGS. 22 to 24, the rear side of the spoke body 251 is provided with a main body recess 255 recessed forward. In this embodiment, the main body recess 255 is formed in an arcuate shape so as to surround the spoke through-hole 217 from the side remote from the axis Z. The wall surface (side wall surface 257) defining the upper edge, the left and right side edges, and the lower edge of the main body recess 255 extends in parallel with the axis Z, and the wall surface (bottom surface 259) defining the front end of the main body recess 255 extends orthogonally to the Z axis.

The switch unit 253 includes a unit main body 261, a touch sensor 233, a circuit board 267 mounted with multiple light sources 265, and a diffuser 269.

The unit main body 261 is formed by a member made of resin. The unit main body 261 is fitted into the main body recess 255. The unit main body 261 includes a front housing 271 forming a rear end part thereof, and an intermediate housing 273 extending forward from the front housing 271.

The front housing 271 has a flat plate shape, and defines a surface continuous with the spoke body 251 on the rear surface (also referred to as the surface) thereof. The first inclined surface 225A, the second inclined surface 225B, and the spoke recess 235 are provided on the rear surface of the front housing 271.

The front housing 271 has a translucency to allow light from the light source 265 to pass through at least in parts corresponding to the first accepting portion 227A to seventh accepting portion 227G. When the entire front housing 271 is made of a translucent resin member, the part of the rear side of the front housing 271 that does not correspond to the first accepting portion 227A to the seventh accepting portion 227G may be covered with a coating film of non-translucent paint (for example, black paint).

The intermediate housing 273 is formed as a wall extending forward from the front surface (also referred to as the back surface) of the front housing 271. The intermediate housing 273 may be configured to form a wall extending along the side wall surface 257 of the main body recess 255. A gap is provided between the front end (protruding end) of the intermediate housing 273 and the bottom surface 259 of the main body recess 255. The front end of the intermediate housing 273 is provided with a bent portion 275 that is bent back away from the side wall surface 257 defining the main body recess 255. The bent portion 275 is preferably shaped like a plate having a major surface substantially parallel to the bottom surface 259 of the main body recess 255.

An elastic member 277 is provided between the intermediate housing 273 and the wall surface defining the main body recess 255. In this embodiment, the elastic member 277 is provided between the bent portion 275 of the intermediate housing 273 and the bottom surface 259 of the main body recess 255. The elastic member 277 is respectively adhered to the intermediate housing 273 and the wall surface defining the body recess 255. The elastic member 277 compressively deforms under a load applied from the intermediate housing 273 against the wall surface defining the main body recess 255, and restores the original shape thereof when the load is removed. The elastic member 277 may also consist of other biasing members such as a spring, or may consist of an elastically deformable rubber member (for example, silicone rubber).

The touch sensor 233 is formed of a sheet-like member having translucency. The touch sensor 233 may be a capacitive proximity sensor or contact sensor, or may be a resistive contact sensor. The touch sensor 233 is positioned along the surface of the front housing 271 and connected to the front housing 271.

The circuit board 267 is positioned on the back surface side of the front housing 271. The circuit board 267 consists of a flat board known as a printed circuit board, and in this embodiment, consists of a double-sided circuit board having patterns on both sides thereof. The circuit board 267 is positioned so that the major plane thereof is perpendicular to the axis Z. Hereinafter, the surface of the circuit board 267 facing the rear will be referred to as the front surface, and the surface facing the front will be referred to as the back surface. The circuit board 267 is supported by the front housing 271 via the diffuser 269.

The light sources 265 are provided on the surface of the circuit board 267 facing the front housing 271, or the rear surface thereof (hereinafter referred to as the front surface). The light sources 265 each consist of an LED device (light emitting diode), and may be in the form of a chip. The light sources 265 are aligned in the fore and aft direction with the corresponding accepting portions 227 in an overlapping relationship.

The diffuser 269 has a wall shape that protrudes forward from the back surface of the front housing 271. The diffuser 269 is connected to the back surface of the front housing 271 and the front surface of circuit board 267. The diffuser 269 consists of a material that diffuses the light incident from the light sources 265. The diffuser 269 may be formed, for example, by dispersing particles in a transparent resin having a different refractive index. The diffuser 269 is preferably made of polystyrene resin, polymethyl methacrylate resin, or the like.

The diffuser 269 has a wall shape extending along the gaps defined between the light sources 265. In other words, no two light sources 265 are positioned in the same area on the circuit board 267 divided by the diffuser 269, and only one of the light sources 265 is positioned in each area defined by the diffuser 269.

When the light source 265 emits light, the part of the front housing 271 aligning with the corresponding accepting portion 227 is illuminated from the front side. Since the front housing 271 is translucent, the driver is able to visually recognize that the part of the front housing 271 corresponding to the accepting portion 227 is emitting light. Since the diffuser 269 is provided between the light sources 265, the diffuser 269 prevents the light emitted from each light source 265 from reaching the part of the front housing 271 where no accepting portion 227 is provided so that the undesired accepting portions 227 are prevented from being illuminated.

A press switch 279 is provided on the side of the circuit board 267 facing away from the front housing 271, or on the back side thereof. The press switch 279 is a switch that is turned on and off by pressing a pressing surface 279S thereof. In this embodiment, the bottom surface 259 of the spoke recess 235 is provided with a pillar 281 projecting forward (i.e., toward the press switch 279) at a part thereof corresponding to the pressing surface 279S of the press switch 279. The press switch 279 is a switch (for example, a push button switch) that gives a reaction force or a tactile reaction to the circuit board 267 and the bottom surface 259 of the spoke recess 235 when the pressing surface 279S is pressed.

The touch sensor 233 is connected to the circuit board 267 via a cable 283. The cable 283 may pass through a through hole (not shown in the drawings) provided in the front housing 271, or may pass through a gap between the front housing 271 and the wall surface defining the main body recess 255. The cable 283 may be a flat cable known as FPC (flexible flat cable) which includes a plurality of conductors extending in parallel to each other, and a pair of sheets of insulating material interposing the conductors therebetween.

The circuit board 267 is connected via a cable (not shown) to a control device 285 (see FIG. 20) provided on the vehicle body. The control device 285 is a computer equipped with a central processing unit (CPU), memory devices such as RAM (random access memory) and ROM (read only memory), and a storage device such as an SSD (solid state drive) and HDD (hard disk drive). The control device 285 operates the operation objects according to the input operation received by the accepting portions 227, and supplies driving electric power to the light sources 265 provided on the circuit board 267.

In this embodiment, the control device 285 uses the touch sensor 233 to acquire the swipe amount applied to the first accepting portion 227A (see the broken line in FIG. 21; hereinafter referred to as the detection area) on the rear surface of the spoke 215 as an input operation. Further, the control device 285 determines that an input operation different from a swipe amount is applied to the first accepting portion 227A when a central part (where denoted with “OK”) of the area corresponding to the first accepting portion 227A is touched, and a pressure is detected by the press switch 279.

When the touch sensor 233 detects a touch operation on the second accepting portion 227B on the rear surface of the spoke 215, the control device 285 determines if the touch position is on the left or right side of the second rib 229B, and accepts a selection operation either for the left side or the right side accordingly.

When the touch sensor 233 detects a contact in any one of the areas corresponding to the third accepting portion 227C to the seventh accepting portion 227G (see the broken line in FIG. 21) and the press switch 279 detects a pressure, the control device 285 then determines that an input operation has been made to the corresponding one of the third accepting portion 227C to the seventh accepting portion 227G.

When only a touch operation is inputted to the seventh accepting portion 227G, the control device 285 blinks the direction indicator for a predetermined number of times (for example, three times). Further, when the press switch 279 is turned on, the direction indicator may start flashing and continue flashing until the turn maneuver is completed.

Next, the effects of the steering wheel 205 and the switch unit 253 configured in this manner will be discussed in the following.

The first accepting portion 227A and the second accepting portion 227B are provided on the inclined surface 225 that is inclined with respect to the imaginary plane P perpendicular to the axis Z of the steering shaft 207. Therefore, the driver can easily recognize the positions of the first accepting portion 227A and the second accepting portion 227B by means of the inclination angle of the inclined surface 225. Therefore, the driver can perform the input operation without looking so that the input operation to the steering switch 219 is facilitated.

The first accepting portion 227A and the second accepting portion 227B are provided on the inclined surface 225 that is inclined forward as one moves radially inward toward the Z axis. Since the first accepting portion 227A and the second accepting portion 227B are provided on the inclined surface 225 that is inclined along the thumb of the driver who grips the rim 211, the input operation to the first accepting portion 227A and the second accepting portion 227B input operation is facilitated.

The first accepting portion 227A and the second accepting portion 227B are provided so as to overlap with the second inclined surface 225B located radially outward of the first inclined surface 225A. Therefore, as compared to the case where the first accepting portion 227A and the second accepting portion 227B are both provided only on the first inclined surface 225A, the first accepting portion 227A and the second accepting portion 227B are provided more radially outward, and closer to the rim 211. Therefore, the first accepting portion 227A and the second accepting portion 227B are positioned closer to the thumb of the driver's hand (see the double-dot chain line in FIG. 21) holding the rim 211. Thereby, input operations to the first accepting portion 227A and the second accepting portion 227B are facilitated. In the present embodiment, as indicated by the double-dot chain line in FIG. 21, the driver can perform an input operation to the second accepting portion 227B by moving the thumb while gripping the rim 211.

The spoke recess 235 which is recessed forward with respect to the imaginary plane P is provided in the lower edge portion 223 of the spoke 215. This creates a space A defined by the spoke recess 235 at the lower edge portion 223 of the spoke 215. A driver who grips the rim 211 and performs a driving operation can place his thumb in the spoke recess 235 and put the thumb into the space A. As a result, a steering wheel 205 that is easy for the driver to operate and hold is provided.

The second ridge 245 defined between the second surface 239 and the third surface 241 slopes rearward and downward as one moves radially outward. As a result, the second ridge 245 is aligned with the length of the thumb of the driver who grips the rim 211. Therefore, the driver can easily place the thumb between the second surface 239 and the third surface 241, and can easily perform an input operation to the accepting portion 227.

The seventh accepting portion 227G that accepts an input operation related to the turn signal operation is provided on the third surface 241. Therefore, compared to the case where the seventh accepting portion 227G is provided on the first surface 237 or the second surface 239, the driver can easily perform the input operation related to the turn signal operation because the seventh accepting portion 227G is positioned more radially outward. In particular, the turn signal operation is more frequently performed than, for example, an operation related to a warning sound, so the operability and convenience of the steering wheel 205 are improved. The stepped portion 242 is provided radially outward of the third surface 241. Therefore, the stepped portion 242 functions as a guide for indicating the position of the third surface 241, and the driver can easily recognize the position of the third surface 241 by touching the stepped portion 242.

The third accepting portion 227C to the seventh accepting portion 227G that accept an input operation from the driver are provided so as to be within the spoke recesses 235. Since the spoke recess 235 is formed as a recess on the rear surface of the spoke 215, the driver can recognize the position of the spoke recess 235 by touching it. Therefore, the driver can recognize the positions of the third accepting portion 227C to the seventh accepting portion 227G without visually recognizing them. Therefore, a steering wheel 205 and a switch unit 253 that facilitate input operations for the driver who is performing the driving operation are provided.

The angle formed between the first surface 237 and the second surface 239 is set to be 90 degrees or greater. Therefore, even when the first surface 237 and the second surface 239 are provided with the third accepting portions 227C to the seventh accepting portions 227G, the spoke recess 235 is prevented from becoming excessively deep so that the driver can perform input operations (touch operations) to the third accepting portion 227C to the seventh accepting portion 227G with ease.

The first surface 237, the second surface 239, and the third surface 241 have mutually different angles of inclination. Therefore, the driver can distinguish the first surface 237, the second surface 239, and the third surface 241 from one another according to the inclination angles. Therefore, the driver can perform input operations to the accepting portions 227 provided on the first surface 237, the second surface 239, and the third surface 241 in a selective manner.

The angle formed between the first ridge 243 and the second ridge 245, the angle formed by the second ridge 245 and the third ridge 247, and the angle formed by the third ridge 247 and the first ridge 243 are all set to be 90 degrees or greater. As a result, the spoke recess 235 is prevented from becoming excessively deep so that the driver can easily perform an input operation (touch operation) to any of the third accepting portion 227C to the seventh accepting portion 227G.

As shown in FIG. 21, the first surface 237 is provided with a third rib 229C. As a result, the first surface 237 is divided into two parts by the third rib 229C, or a radially inner part and a radially outer part. The third accepting portion 227C and the fourth accepting portion 227D are provided in the parts of the first surface 237 divided by the third rib 229C.

The second surface 239 is provided with a fourth rib 229D. As a result, the second surface 239 is divided into two parts by the fourth rib 229D, or a radially inner part and a radially outer part. The fifth accepting portion 227E and the sixth accepting portion 227F are provided in the parts of the second surface 239 divided by the fourth rib 229D.

By touching the first surface 237 and the second surface 239, the driver holding the rim 211 can recognize the positions of the third rib 229C and the fourth rib 229D. Accordingly, the driver can recognize the parts of the first surface 237 and the second surface 239 which are divided by the third rib 229C and the fourth rib 229D without visually recognizing them. Therefore, the driver can easily and selectively perform input operations to any of the third accepting portion 227C to the sixth accepting portion 227F.

When the driver presses forward with a sufficient load any one of the third accepting portion 227C to the seventh accepting portion 227G, the contact position of the driver is acquired by the touch sensor 233, and the press switch 279 is turned on. Thereby, the control device 285 is enabled to determine if an input operation with a pressure large enough to turn on the press switch 279 is performed at the contact position acquired by the touch sensor 233. Therefore, it is possible to prevent erroneous input due to an unintended contact with the steering wheel 205 made by the driver.

The first accepting portion 227A is provided with the first rib 229A, and the second accepting portion 227B is provided with the second rib 229B. The extending directions of the first rib 229A and the second rib 229B are different from each other. Therefore, the driver can distinguish between the first rib 229A and the second rib 229B based on the extending directions thereof. As a result, the driver can selectively perform an input operation to either the first rib 229A or the second rib 229B without looking so that a steering wheel 205 and a switch unit 253 that facilitate input operations for the driver are provided.

The driver is able to distinguish the first rib 229A and the second rib 229B from each other by tracing the ridges in the vertical direction. As the driver traces the first rib 229A downward, the first rib 229A extends in a direction approaching the axis Z of the steering shaft 207. As the driver traces the second rib 229B downward, the second rib 229B extends in a direction moving away from the axis Z of the steering shaft 207. Therefore, the driver can distinguish between the first rib 229A and the second rib 229B by tracing the ridges in the vertical direction and determining if the extending direction of the ridges approaches the axis Z or not.

The first accepting portion 227A acquires the swipe amount of the driver in the direction intersecting the first rib 229A, and the second accepting portion 227B acquires the contact position of the driver in the direction intersecting the second rib 229B. In this way, the corresponding ridges of the first accepting portion 227A and the second accepting portion 227B are located in the central parts of the respective detection regions, so that the driver can easily recognize the position to which a contact or an approach should be made (or the position to which the input operation should be applied) without looking.

The first rib 229A and the second rib 229B both pass through the inclined surface 225. Therefore, the driver can easily recognize the positions where the first rib 229A and the second rib 229B are located from the inclination angle of the inclined surface 225.

The first rib 229A and the second rib 229B are located so as to pass through the second inclined surface 225B. Therefore, the first accepting portion 227A and the second accepting portion 227B are positioned so as to overlap with the second inclined surface 225B. As a result, as compared to the case where the first accepting portion 227A and the second accepting portion 227B are located only on the first inclined surface 225A, since the first accepting portion 227A and the second accepting portion 227B are located closer to the rim 211, the input operation is facilitated for the drive who grips the rim 211.

The first accepting portion 227A is positioned at the upper edge part of the rear surface of the spoke 215, and the second accepting portion 227B is positioned at the lateral edge part of the rear surface of the spoke 215. Therefore, the driver can easily recognize the place where the input operation should be made. Further, the first accepting portion 227A extends downward from a vertically middle part of the rim 211 with an inclination toward the rim 211. Therefore, the first accepting portion 227A is positioned along the movable path of the thumb of the drive who grips the rim 211. Therefore, as compared to the case when the first accepting portion 227A extends vertically without any inclination, the input operation to the first accepting portion 227A is facilitated.

In this manner, the spoke body 251, the touch sensor 233 provided on the rear surface of the spoke body 251, and the press switch 279 form the steering switch 219 that receives the driver's input operation. In other words, the steering switch 219 forms a part of the base body of the spoke body 251.

The steering switch 219 acquires the input operation position and swipe amount performed by the driver by the touch sensor 233, and determines if a sufficient pressure is applied to the accepting portion 227 by the press switch 279. Since this configuration eliminates a need to provide a press switch 279 for each accepting portion 227, the structure of the steering wheel 205 is simplified. In addition, when the driver presses the accepting portion 227, the press switch 279 conveys a tactile sense to the driver so that the driver can reliably recognize that the input operation has been performed.

When the light source 265 emits light, the corresponding part of the front housing 271 where the touch sensor 233 is provided is illuminated from the front side. Since the front housing 271 and the touch sensor 233 are translucent, the light which has reached the part of the front housing 271 where the corresponding touch sensor 233 is provided passes through the front housing 271 and the touch sensor 233. As a result, the driver can see the corresponding accepting portion 227 illuminated toward the rear. This allows the driver to easily recognize the position of the accepting portion 227, or the position at which the input operation should be made.

The part of the light emitted from the light sources 265 directed toward regions other than the regions located between the gaps in the diffuser 269 is diffused by the diffuser 269. As a result, the parts of the front housing 271 corresponding to the light sources 265 are selectively illuminated from the front side. Therefore, the accepting portions 227 corresponding to the light sources 265 are visually recognized as emitting light more intensely than other regions, so that the visibility of the positions at which the input operation is to be performed is improved.

The elastic member 277 is provided between the intermediate housing 273 and the wall surface defining the main body recess 255 to connect the two parts. Therefore, the base body is accommodated in the main body recess 255 so as to be displaceable with respect to the spoke body 251. When the driver presses the accepting portion 227 forward, the base body moves forward relative to the spoke body 251 with the result that the press switch 279 is pressed by the bottom surface 259 of the spoke recess 235.

In this manner, the circuit board 267 is supported at the front end of the intermediate housing 273, and since the press switch 279 is provided on the front surface of the circuit board 267, the press switch 279 can be operated by a forward pressing force applied to the base body. In other words, since the circuit board 267 is supported on the front end of the intermediate housing 273, and the press switch 279 is positioned on the front surface of the circuit board 267, the press switch 279 can be placed between the base body and the wall surface defining the main body recess 255 so that the switch is operated by the pressing force.

The touch sensor 233 is connected to circuit board 267 via the cable 283. Therefore, when the base body moves forward due to the pressing force of the driver, no relative displacement is caused between the touch sensor 233 and the circuit board 267. Therefore, a tensile load is prevented from being applied to the cable 283 connected to the touch sensor 233 due to the displacement of the base body with respect to the spoke body 251.

### Fifth Embodiment

The steering wheel 205 according to the fifth embodiment of the present invention differs in the positioning of the press switch 279, but is otherwise similar to that of the fourth embodiment. Therefore, the description of the similar parts is omitted is omitted in the following description.

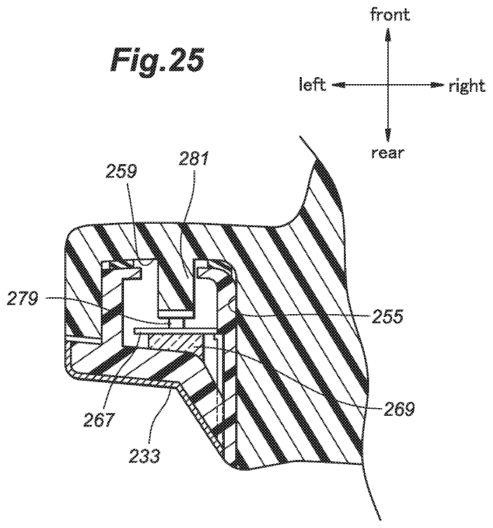

FIG. 25 is a cross-sectional view corresponding to a sectional view taken along line III-III in FIG. 21 and showing the steering wheel 205 according to the fifth embodiment of the present invention. In the fifth embodiment, the press switch 279 is provided on the bottom surface 259 of the main body recess 255. More specifically, the press switch 279 is positioned on the tip end surface of the pillar 281 provided on the bottom surface 259 of the main body recess 255 so as to oppose the circuit board 267. The press switch 279 is preferably connected to the circuit board 267 via wiring.

Next, the effects of the steering wheel 205 and switch unit 253 of the fifth embodiment will be discussed in the following.

When the driver presses the base body forward in order to perform an input operation to the accepting portion 227, the circuit board which is supported by a circuit board base body moves forward under the pressing force. As a result, the press switch 279 is pushed by the circuit board 267 and is thereby turned on. Thus, by providing the press switch 279 on the bottom surface 259 of the main body recess 255, the press switch 279 can perform a switching action by being positioned between the base body and the wall surface defining the main body recess 255.

### Modifications of Fourth and Fifth Embodiments

In the fourth and fifth embodiments mentioned above, the first surface 237 and the second surface 239 were provided with the third rib 229C and the fourth rib 229D, respectively. However, the present invention is not limited to these examples. For example, it suffices for the present invention if any one of the first surface 237, the second surface 239 and the third surface 241 is provided with a rib that extends in a predetermined direction and divides the corresponding surface into two parts, and an accepting portion 227 is provided in each of the parts divided by the rib.

In the fourth and fifth embodiments described above, the accepting portions 227 were provided within the first surface 237, the second surface 239, and the third surface 241, respectively, but the present invention is not limited to this configuration. It suffices for the present invention as long as at least a part of the accepting portion 227 is provided so as to overlap with the spoke recess 235. Accordingly, the driver can recognize the position thereof by touching the spoke recess 235 without visually recognizing it. Thus, a steering wheel 205 that facilitates an input operation for the driver while performing the driving operation is provided.

In the fourth and fifth embodiments, multiple accepting portions 227 were formed by a single common touch sensor 233. Alternatively, for example, an individual touch sensor 233 may be provided for each accepting portion 227. A single touch sensor may form one or two of the accepting portions. Alternatively, the third accepting portion 227C to the seventh accepting portion 227G may be formed by a single touch sensor 233. The input operation that is accepted by each accepting portion 227 is not limited to the above-mentioned modes, but may also be other modes such as contact, proximity, swipe (scrolling, tracing), pressing, or a combination thereof.

### <Head-Up Display>

The steering switch 219 according to the present invention can be used to change the display contents of the display. The display whose display content is to be changed may be, for example, a head-up display 289 that displays information on a front window 287 located in front of the driver.

However, when the head-up display 289 is provided on the front window 287, there is a possibility that the display may hinder the driver's driving operation. Here, as one embodiment, a display system 288 will now be described in the following in which the control device 285 changes the display contents of the head-up display 289 based on the input to the steering switch 219 so that the driving operation is prevented from being hindered. However, this embodiment merely shows an example of the processing performed by the control device 285 based on an input to the steering switch 219, and the present invention is not limited to this aspect.

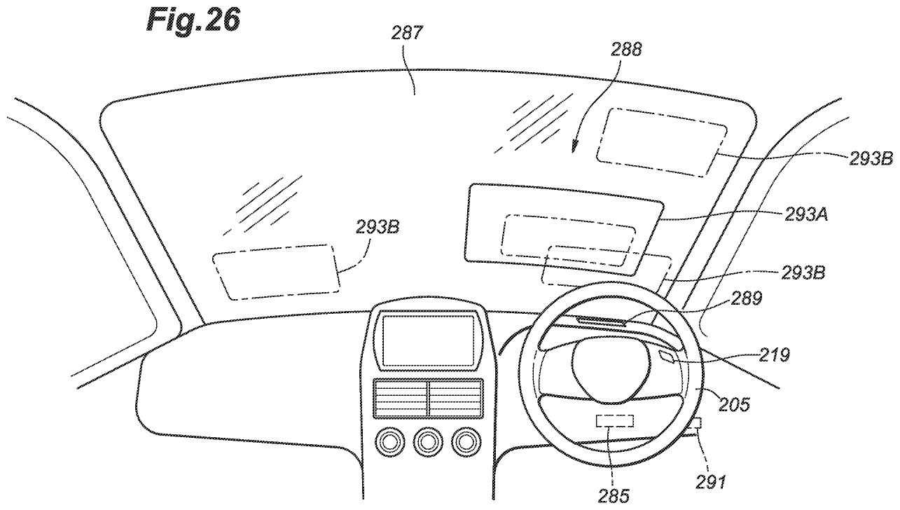

As shown in FIG. 26, the display system 288 includes, in addition to the control device 285, a user interface, a head-up display 289, and a vehicle state sensor 291 that detects the vehicle state.

The user interface is composed of various devices including a steering switch 219. The vehicle state sensor 291 includes a vehicle speed sensor that detects the speed of the vehicle, an inter-vehicle distance detection sensor that detects the inter-vehicle distance, and the like. The vehicle state sensor 291 may also include an acceleration sensor that detects the acceleration of the vehicle. The inter-vehicle distance detection sensor may be composed of, for example, a lidar, radar, sonar, or the like.

The head-up display 289 projects an image onto the front window 287 to display information at a position that is easily visible to the driver. The head-up display 289 may display, for example, the vehicle speed, the remaining amount of fuel or battery charge, and route information and directions of travel provided by the car navigation system.

The control device 285 sets the content to be displayed on the head-up display 289 (for example, a speedometer, etc.) based on the signal from the vehicle state sensor 291 and user interface inputs. Further, the control device 285 controls the head-up display 289 to display the contents that are set. In addition, the control device 285 determines, based on the information acquired by the vehicle state sensor 291, if caution is required in the driving operation, or the degree to which caution is required, and changes the display mode of the head-up display 289 depending on the determination result.

Based on the vehicle state acquired by the vehicle state sensor 291, the control device 285 determines if cautious driving is required. More specifically, the control device 285 determines if the vehicle speed is equal to or lower than a predetermined vehicle speed threshold value (80 km or lower, for instance) and the inter-vehicle distance is equal to or greater than a predetermined distance threshold value (30 m or more, for instance). When the vehicle speed is equal to or lower than the vehicle speed threshold value and the inter-vehicle distance is equal to or greater than the inter-vehicle distance threshold value, the control device 285 sets the display area of the head-up display 289 at a first display area 293A which is located in a lower front part of the front window 287 in front of the driver's seat as indicated by the solid line in FIG. 26.

When the vehicle speed is greater than the vehicle speed threshold value or the inter-vehicle distance is less than the inter-vehicle distance threshold value, the control device 285 sets the display area of the head-up display 289 to a second display area 293B on the front window 287. The second display area 293B is set to be smaller than the first display area 293A as indicated by the double-dot chain line in FIG. 26.

The second display area 293B may be set to an area shifted from the position in front of the driver (or an area which is less likely to hinder the driving operation) as compared to the first display area 293A, as indicated by the single-dot chain line in FIG. 26. For example, the second display area 293B may be set closer to the side of the assistant's seat than the first display area 293A, or may be set at an upper edge part or a lower edge part of the front window 287. In these cases also, the second display area 293B may be set smaller than the first display area 293A.

In addition, when the vehicle speed is greater than the vehicle speed threshold value or the inter-vehicle distance is less than the inter-vehicle distance threshold value, the control device 285 may dim the display of the head-up display 289. When the vehicle speed is greater than the vehicle speed threshold value or the inter-vehicle distance is less than the distance threshold value, in addition to place the display of the head-up display 289 in such a position as not to hinder the driving operation, the control device 285 may notify the driver by notification means (sound, light, vibration, etc., or a combination thereof).

### <Steering Wheel>

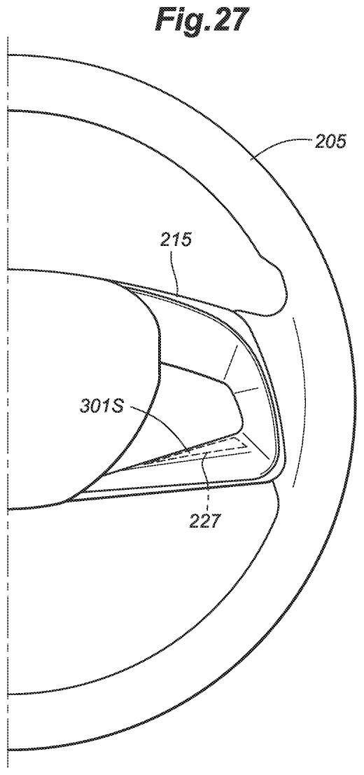

The form of the steering wheel 205 is not limited to that shown in FIGS. 20 and 21. For example, as shown in FIG. 27, the spoke 215 may be provided with a surface 301S whose orientation continuously changes (for example, a surface that changes from top to rear; also referred to as a twisted surface) toward the radially outward part thereof. In that case, the accepting portion 227 of the steering switch 219 may be provided on such a surface.

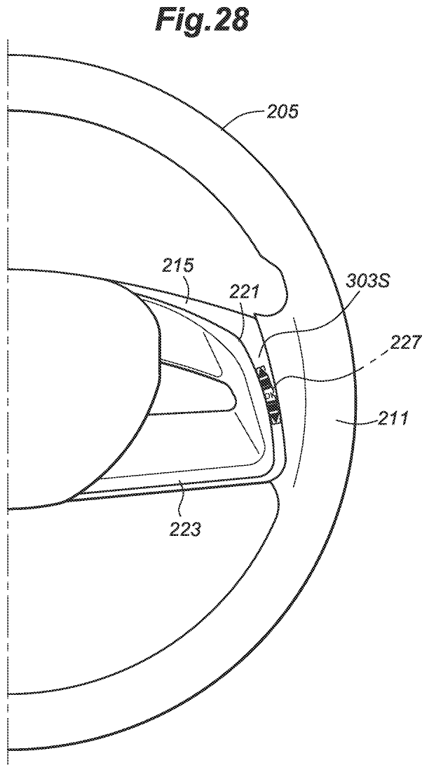

In the above-described embodiments, the accepting portion 227 for detecting the swipe amount was provided on the peripheral edge portion 221, but the present invention is not limited to this aspect. For example, as shown in FIG. 28, a surface 303S (a surface three-dimensionally connected to the rim 211) that is located radially outside the peripheral edge portion 221 so as to form a connecting portion of the spoke 215 to the rim 211 and faces rearward may be provided with an accepting portion 227 for detecting the swipe amount. Also, the accepting portion 227 that detects the swipe amount may be provided along the lower edge of the lower edge portion 223.

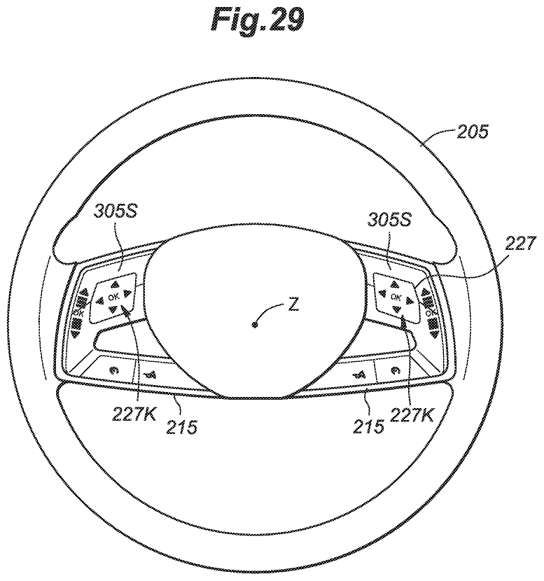

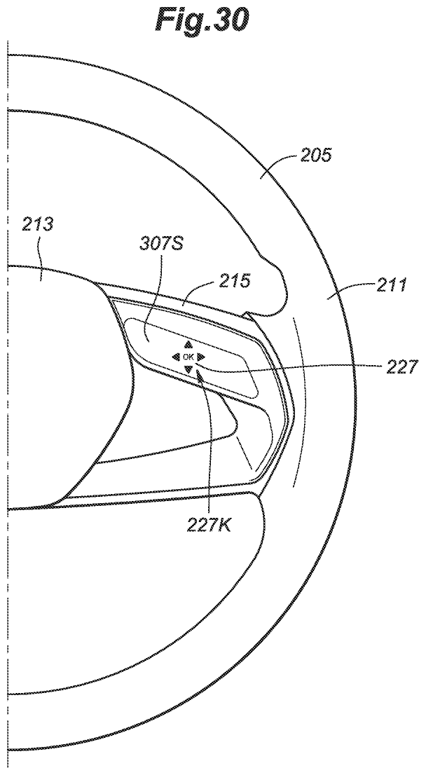

As shown in FIGS. 29 and 30, the steering wheel 205 may be provided with a pair of accepting portions 227 as cross keys 227K for receiving inputs relating to up, down, left, and right directions. In such a case, the cross keys 227K may be provided on substantially flat surfaces 305S and 307S defined on the rear surface of the spoke 215. By configuring in this way, the cross keys 227K are easily visible. Further, as shown in FIG. 29, the accepting portions 227 provided on the steering wheel 205 are preferably arranged symmetrically with respect to the axis Z of the steering wheel 205.

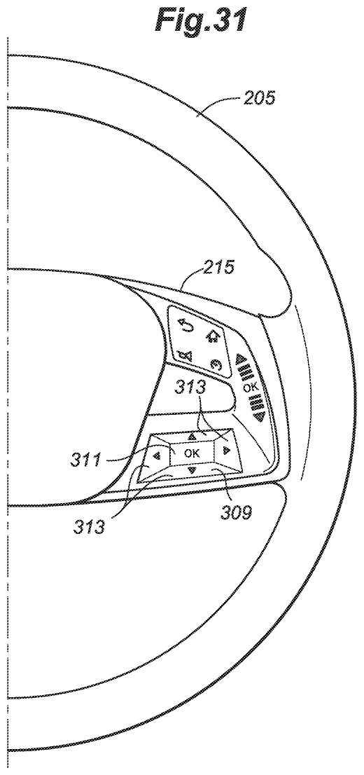

As shown in FIG. 31, the spoke 215 may be provided with a recess 309 that is recessed forward and shaped like an inverted truncated square pyramid. The recess 309 is defined by a square recess bottom surface 311 and four trapezoidal recess edge surfaces 313 surrounding the recess bottom surface 311. In this case, a cross key 227K may be provided on the bottom surface 311 of the recess 309. Also, a cross key 227K may be provided on trapezoidal recess edge surfaces 313. By providing the cross key 227K in the recess 309 in this way, the driver can easily recognize the position of the cross key 227K so that the operability of the cross key 227K can be improved.

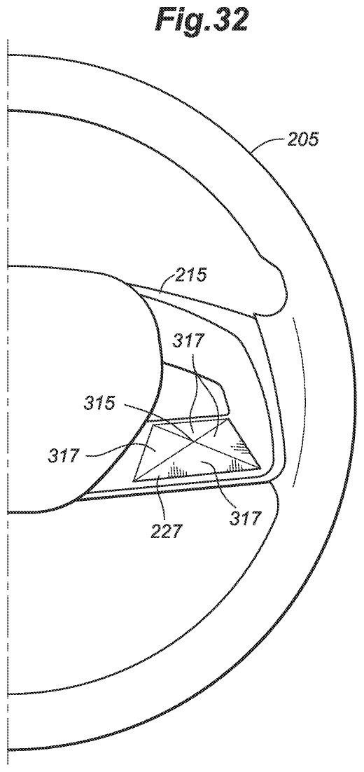

As shown in FIG. 32, the spoke 215 may be provided with a protrusion 315 that has a quadrangular pyramid shape and protrudes rearward. In this case, the accepting portion 227 may be provided on the wall surface defining the protrusion 315. The accepting portion 227 is preferably configured as a touch sensor 233. As a result, the driver can recognize the position of the accepting portion 227 by touching the protrusion 315 so that the operability of the steering switch 219 is improved.

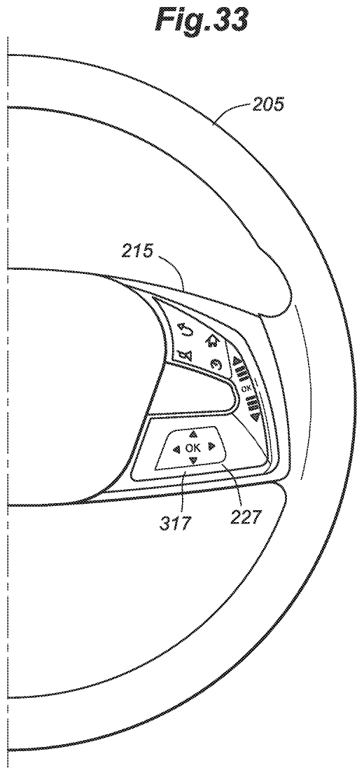

Further, as shown in FIG. 33, a touch panel 317 may be provided on the rear surface of the spoke 215, and an accepting portion 227 for receiving an input operation from the driver may be displayed on the touch panel 317.

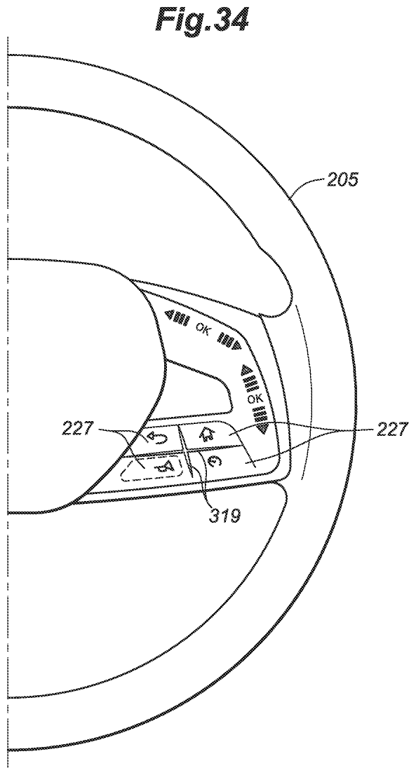

As shown in FIG. 34, a cross-shaped rib 319 may be provided between accepting portions 227, and the accepting portions 227 (touch sensors 233) may be provided adjacent to the rib 319. In this case, preferably, the rib 319 is provided so as to pass between the adjacent accepting portions 227. As a result, the rib 319 functions as a boundary line of the accepting portions 227 (touch sensors 233), so that the driver can recognize the positions of the accepting portions 227 without looking.

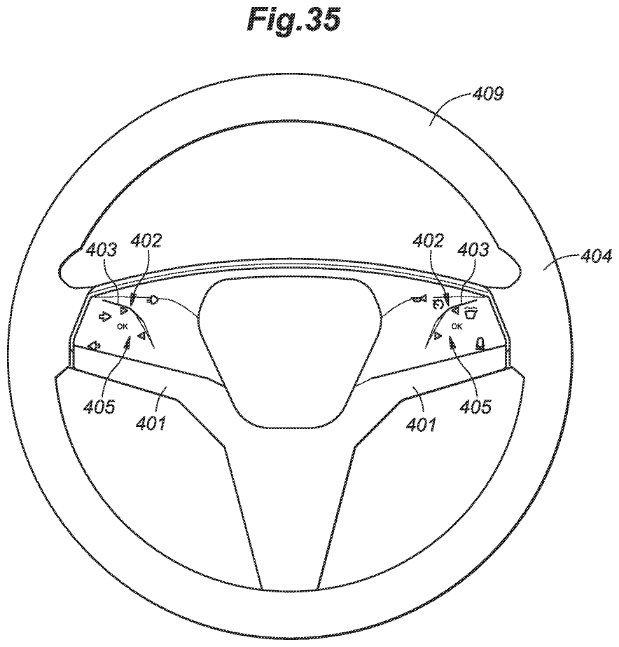

As shown in FIG. 35, the left and right parts of the spoke 401 may be each provided with an input device 402, and each input device 402 may be provided with a rib 403 projecting toward the driver. At this time, the rib 403 has an arcuate shape (rounded shape) that curves so as to protrude toward the axis of the steering shaft 7 along the trajectory of the movement of the thumb of the driver who grips the rim portion 404. A recess 405 that is recessed in a direction away from the driver may be provided on the side part of the rib 403 facing the rim portion 404. The recess 405 may extend in the same arcuate shape as the rib 403 on the side of the rib 403 adjacent to the rim portion 404.

The protruding height of the rib 403 and the depth of the recess 405 may each be configured to vary along the extending direction thereof. More specifically, the protruding height of the rib 403 may be configured to be the greatest at the approximately central part thereof in the extending direction. The depth of the recess 405 may be configured to be the greatest (deepest) at approximately the central part thereof in the extending direction. As a result, when the driver traces the rib 403 with his thumb, he can easily understand the substantially central part of the extending direction.

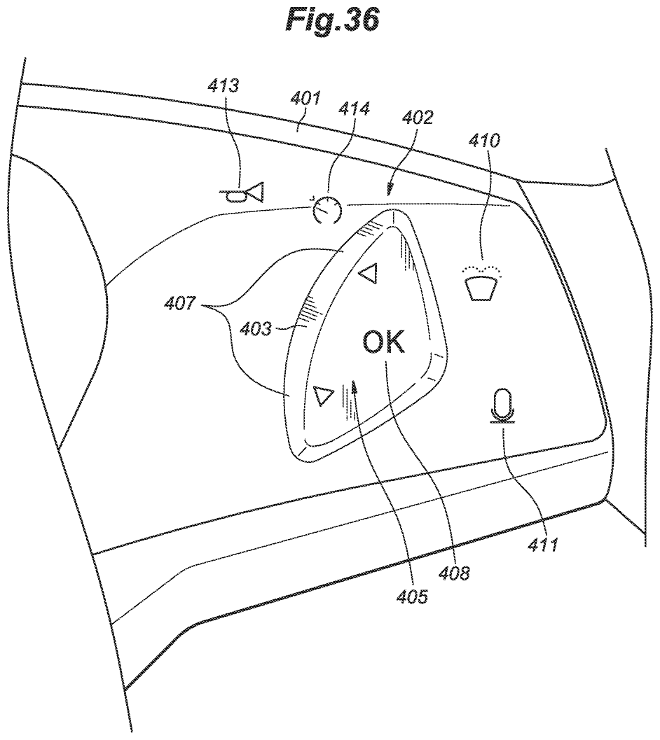

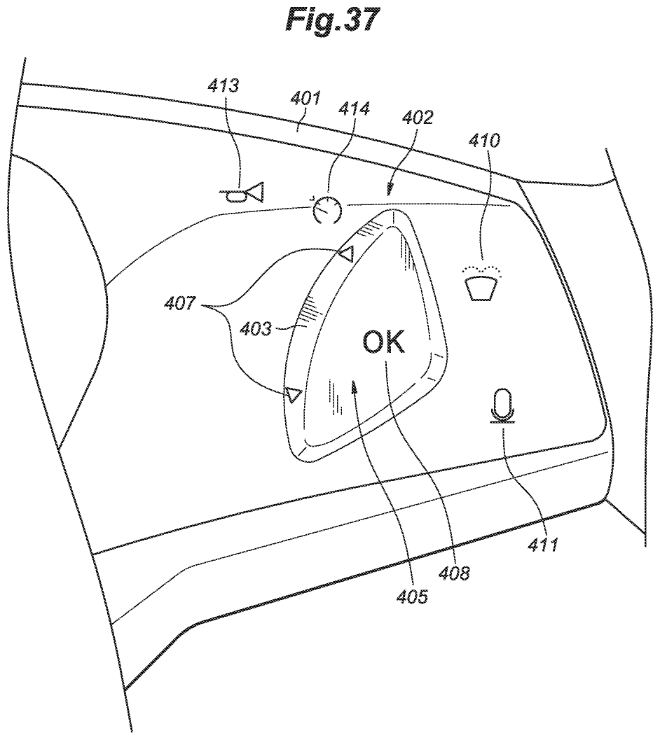

As shown in FIG. 36, a part of a recess 405 adjoining the rim portion 404 (or the inside part of the recess 405) is provided with a pair of selection buttons 407 (selection portion) and a decision button 408 (decision portion) for performing various selections. However, the present invention is not limited to this configuration, and as shown in FIG. 37, the decision button 408 (selection buttons 407) may be provided on the side of the rib 403 adjacent to the axis (central part) of the steering wheel 409. The part of the spoke 401 corresponding to the selection button 407 and the decision button 408 may be provided with a sensor that detects a contact and/or a pressure from the driver.

As shown in FIGS. 36 and 37, the rear surface of the spoke 401 may also be provided with a washer switch 410 (windshield washer liquid ejection operation portion), an audio input switching button 411 (audio input switching portion), a horn operation button 413 (horn operation portion), and a monitor display operation button 414 (monitor display operation portion). The monitor display operation button 414 preferably accepts an input operation for changing the information displayed on the monitor (also referred to as a multi-information display) on which the combination meter is displayed.

Alternatively, the steering wheel 409 may be detachable from the vehicle body. Thereby, when the vehicle is being autonomously driven, the driver is not required to reach out to the steering wheel which is otherwise fixed to the vehicle body so that the operability of the vehicle can be improved.

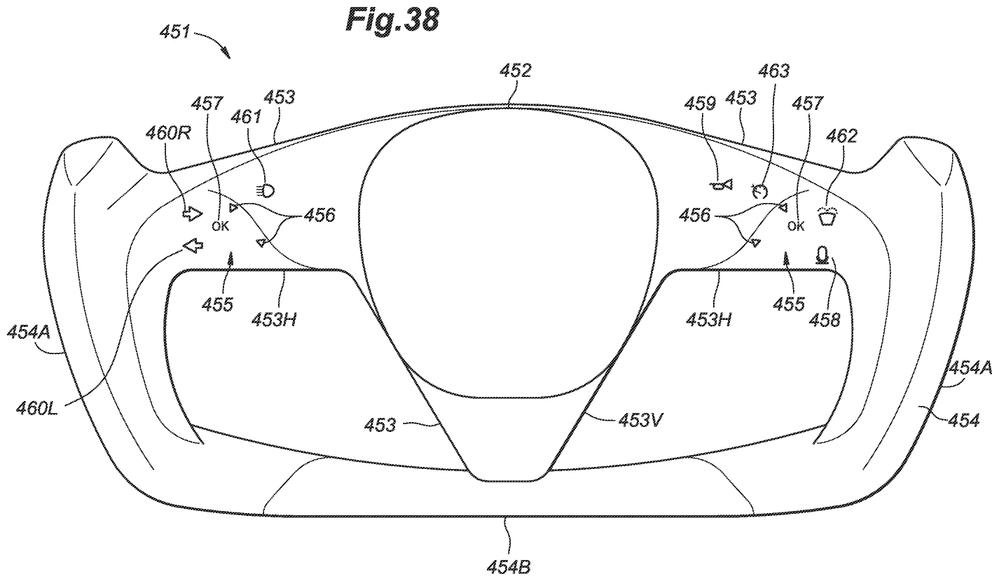

As shown in FIG. 38, the steering wheel 451 may include a hub 452 connected to the steering shaft 7, a spoke 453 consisting of multiple parts and extending from the hub 452 in a direction away from the axis of the steering shaft 7, and a control wheel 454 connected the spoke 453. As shown in FIG. 38, the control wheel 454 includes a pair of vertical portions 454A that are positioned on either side of the hub 452, and a horizontal portion 454B that connects the lower ends of the vertical portions 454A, and thereby exhibit a substantially U-shape. The spoke 453 may include a pair of horizontal spoke parts 453H extending away from the hub 452 in the horizontal direction and a vertical spoke 453V extending from the hub 452 in a direction orthogonal to the extending direction of the horizontal spoke parts 453H. In this case, switches 455 (operation unit) for accepting input operations from the driver may be provided in regions extending from the middle parts of the horizontal spoke parts 453H to the lateral outer end parts thereof or the parts of the horizontal spoke parts 453H adjoining the inner parts of the control wheel 454.

In this embodiment, the rear surface of the horizontal spoke parts 453H is provided with a pair of selection buttons 456 (selection portions), a decision switch 457 (decision portion also called as OK switch), an audio input switching switch 458 (audio input selection switch), a horn operation switch 459 (horn operation portion), a left turn signal switch 460L, a right turn signal switch 460R, a headlight switch 461 (headlight switch portion), a washer switch 462 (a washer operation portion), and a monitor display operation button 463.

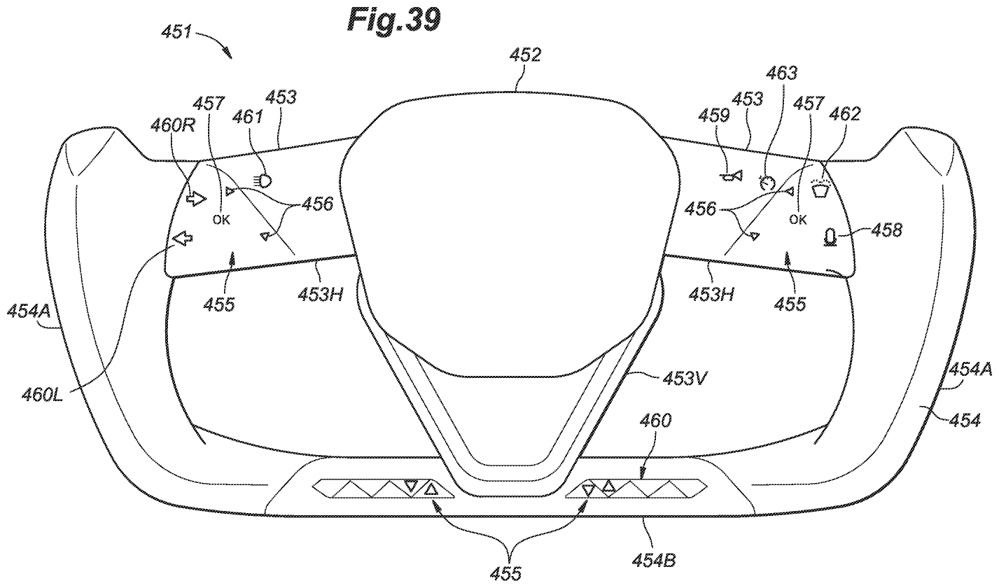

However, the locations where the switches 455 are provided are not limited to the spoke 453 or the connecting part between the spoke 453 and the control wheel 454. The switches 455 may be provided, for example, in a lower edge part of the hub 452, or may be provided along the lower edge of the control wheel 454 as shown in FIG. 39. When the switches 455 are provided in the lower edge part of the control wheel 454, even when the driver's seat is tilted backward and the driver is lying down in an autonomous driving condition, the driver can perform an input operation with his or her index finger or the like. Furthermore, the switches 455 may also be provided on the upper end surface of the vertical portions 454A of the control wheel 454.

The switches 455 may each consist of a capacitance sensor, a touch switch or the like. In this case, the switches 455 may be arranged so as to be distributed over the laterally outer edge part of the spoke 453 and the rear surface of the control wheel 454. As shown in FIG. 39, a flat surface 460 is defined over the laterally outer edge part of the spoke 453 and the rear surface of the control wheel 454, and the switches 455 are constructed by placing capacitance switches on the flat surface 460.

Further, the switches 455 may be composed of a single sheet or a plurality of sheets, and the sheet or the sheets may be arranged so as to reach the hub 452. In such a case, the sheet or sheets may extend over the rear surface of the hub 452 or may pass across the front surface (back side) of the hub 452.

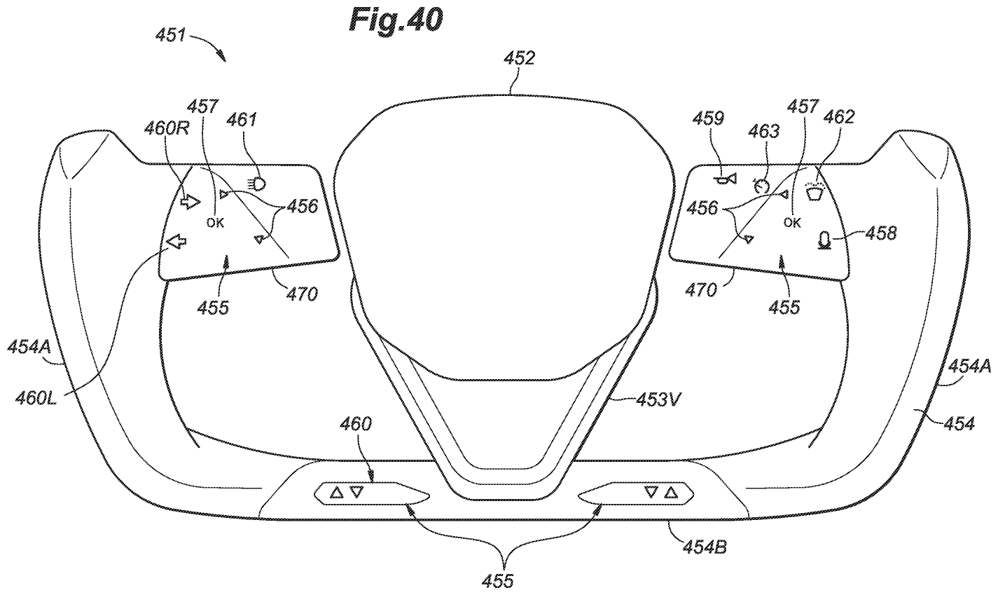

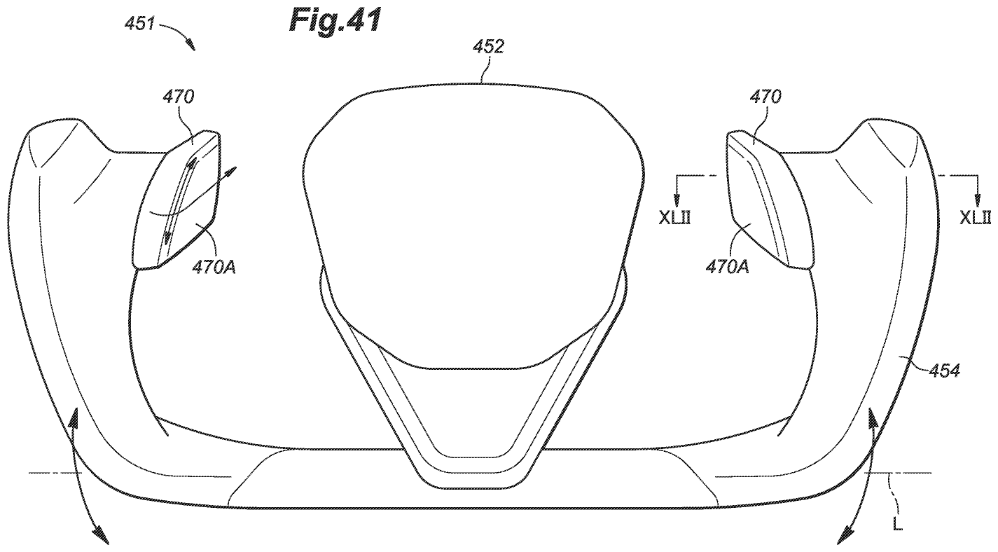

As shown in FIGS. 40 and 41, the control wheel 454 may be connected to the hub 452 only via a single vertical spoke 453V. In this case the steering wheel 451 is not provided with the horizontal spoke parts 453H.

In this case, the parts of the upper end parts of the vertical portions 454A of the control wheel 454 opposing the hub 452 may be provided with accepting portions 470 that protrude toward the hub 452.

As shown in FIG. 40, the accepting portion 470 may extend toward the hub 452 from the upper surface of each vertical portion 454A facing the hub 452, and may have a plate shape with a rearward facing surface. In this case, switches 455 (selection portions) may be provided on the rearwardly facing surfaces of the accepting portions 470.

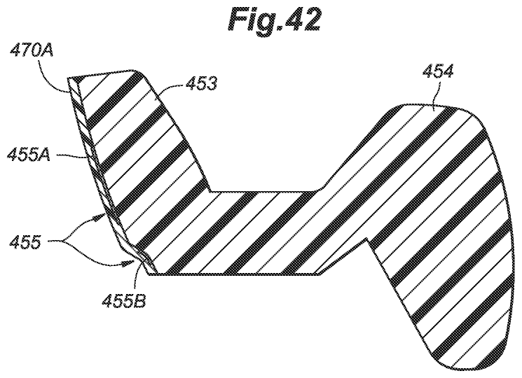

As shown in FIG. 41, each accepting portion 470 may have the shape of a protrusion that protrudes from an upper end part of the vertical portion 454A toward the hub 452. The accepting portion 470 may have a flat surface 470A facing the hub 452 on the tip end surface thereof. As shown in FIGS. 41 and 42, the flat surface 470A may be provided with switches 455A (selection portion) that receive an input performed by pressing, and swiping along the edge of the flat surface 470A. A switch 455B (selection portion) configured to accept a swiping input along an edge of the flat surface 470A may also be provided.

As shown in FIGS. 40 and 41, when the control wheel 454 is connected to the hub 452 only through the vertical spoke 453V, the control wheel 454 may be supported by the lower edge part of the hub 452 so as to be rotatable about an axial line L (see FIG. 41) extending laterally through the lower edge part of the hub 452. As a result, even if the control wheel 454 is not detachable from the hub 452, the driver seated in the seat in a rearwardly tilted state can easily perform the input operation in an autonomous driving condition of the vehicle.

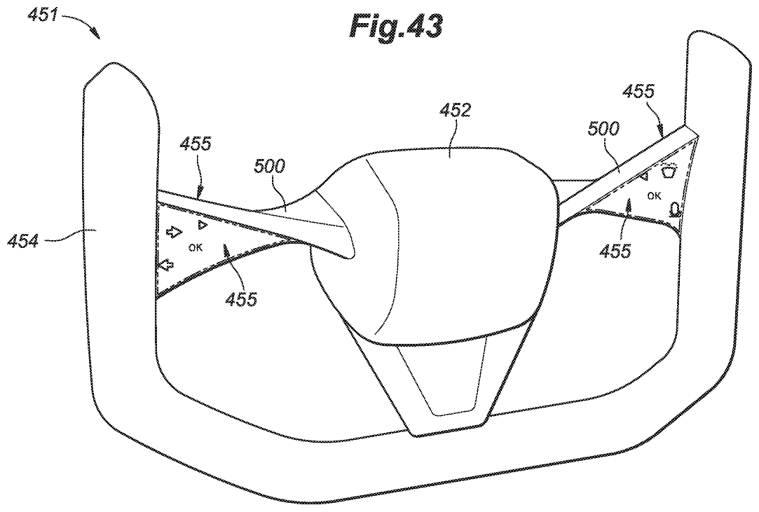

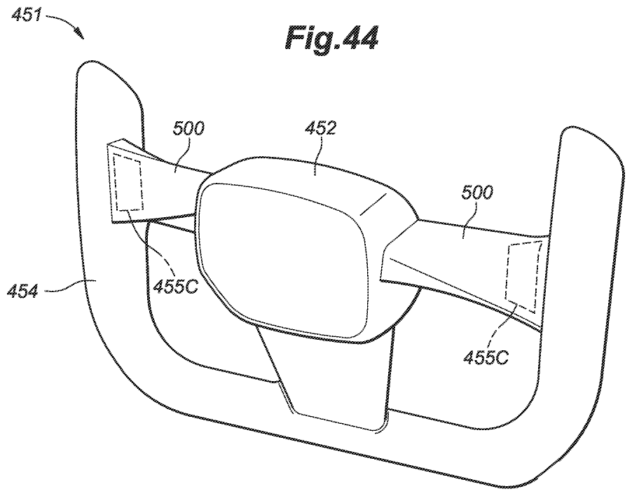

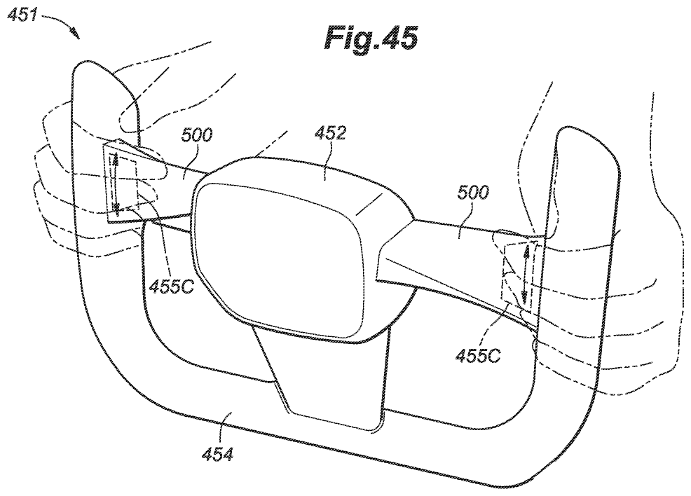

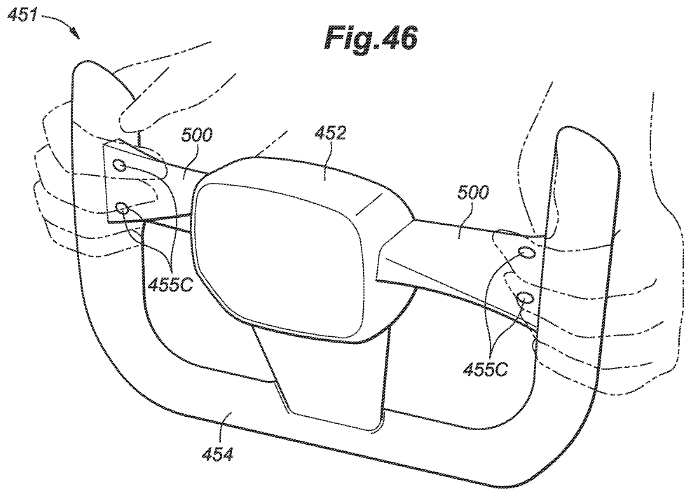

Moreover, as shown in FIGS. 43 and 44, the spoke 500 may be configured in a twisted plate shape twisted about the extending direction of the spoke 500. In this case, the switches 455 for accepting input operations may be arranged on both sides of the major plane of the spoke 500. This arrangement allows the input operation to be performed with ease even when the driver's seat is tilted backward. Further, the switch 455C provided on the reverse surface of the spoke 500 may be configured to accept an input operation by the scrolling (tracing) of the driver's index finger or middle finger, as shown in FIG. 45, and the input operation by tapping may be accepted as shown in FIG. 46.

The present invention has been described in terms of specific embodiments, but is not limited to such embodiments, and can be modified in various ways without departing from the scope of the present invention. Further, the specific configurations, arrangements, quantities, etc. of each member can be changed as appropriate without departing from the gist of the present invention. Moreover, not all of the constituent elements shown in the above embodiments are essential, and can be selected and substituted as appropriate.

REFERENCE NUMERALS

| | |
|---|---|
| 1: input device of the first embodiment | 3: four-wheeled vehicle |
| 4: up, down, left and right | 5: steering wheel |
| 7: steering shaft | 9: steering angle sensor |
| 11: rim (grip portion) | 13: hub |
| 15: spoke | 15L: left spoke part |
| 15R: right spoke part | 17: base portion |
| 19: switch unit | 19L: left switch unit |
| 19R: right switch unit | 21: processing device |
| 27: recess | 29: protrusion |
| 29B: inclined surface | 41: first switch |
| 43: second switch | |
| 101: input device of the second embodiment | |
| 121: input device of the third embodiment | |
| 123: two-wheeled vehicle | 125: bar handle |
| 129: eaves portion (cover) | S: reference plane |
| X: rotational axis | Y: axis (rotational axis) |

1. An input device, comprising,
an operating member including a grip portion configured to be gripped by a user, a recess recessed with respect to a reference plane, and a rib extending along a part of an edge of the recess; and
a switch unit including a first switch configured to detect an input to a surface of the rib facing away from the recess, and a second switch configured to detect an input to a bottom surface of the recess,
wherein the edge of the recess is circular in shape, and the rib extends in an arcuate shape along a part of the edge remote from the grip portion.

2. The input device according to claim 1, wherein the first switch is configured to acquire a contact position on a surface of the rib facing away from the recess.

3. The input device according to claim 1, wherein the grip portion is positioned on an outer edge side of the recess and the rib.

4. The input device according to claim 1, wherein the operating member constitutes a steering operation member that receives an input of a steering angle by being rotated about a rotational axis, and the recess and the rib are positioned closer to the rotational axis than the grip portion, the rib being positioned closer to the rotational axis than the recess.

5. The input device according to claim 4, further comprising a processing device that stores a relationship between the switch unit and operation objects to be operated thereby, and according to an input to the switch unit, provides an output to the corresponding operating object, the processing device ceasing an output to the operating object based on an input to the first switch and the second switch.

6. The input device according to claim 4, wherein the switch unit is one of a pair of switch units that are provided on a rear surface of the steering operation member so as to be symmetric to each other about the rotational axis, and the input device further comprises a processing device that stores a relationship between the switch units and operation objects to be operated thereby, and according to an input to the switch units, provides an output to the corresponding operating object, the processing device interchanging the operating objects of the two switch units depending on the steering angle.

7. The input device according to claim 4, wherein the second switch includes eight touch sensors arranged around a central axis of the recess along a circumferential direction at regular intervals, and a detection device that detects an input operation corresponding to a circumferential direction when sequential contacts of three adjoining ones of the touch sensors are detected, and detects an input operation corresponding to an upward, a downward, a leftward or a rightward direction when two adjoining ones of the touch sensors are simultaneously detected.

8. The input device according to claim 2, further comprising a processing device that selects operation objects of the first switch unit according to an input to the second switch, acquires a displacement of a contact position on the first switch unit, computes a set value according to a prescribed formula, and outputs the set value to each operation object, the processing device determining the formula that gives the set value from the displacement according to a nature of the operation object.

9. The input device according to claim 1, wherein the operating member is provided with a cover that covers both the recess and the rib.

10. The input device according to claim 1, wherein the operating member is provided on a four-wheeled vehicle or a two-wheeled vehicle.
